(19) United States
(12) Patent Application Publication
(10) Pub. No.: US 2018/0324869 A1
(43) Pub. Date: Nov. 8, 2018

(54) UPLINK EARLY DATA TRANSMISSION

(71) Applicant: QUALCOMM Incorporated, San Diego, CA (US)

(72) Inventors: Umesh PHUYAL, San Diego, CA (US); Mungal Singh DHANDA, Slough (GB); Alberto RICO ALVARINO, San Diego, CA (US); Miguel GRIOT, La Jolla, CA (US); Luis LOPES, Swindon (GB); Sebastian SPEICHER, Wallisellen (CH); Haris ZISIMOPOULOS, London (GB); Peter GAAL, San Diego, CA (US)

(21) Appl. No.: 16/024,421

(22) Filed: Jun. 29, 2018

Related U.S. Application Data
(63) Continuation-in-part of application No. 15/964,523, filed on Apr. 27, 2018.
(60) Provisional application No. 62/501,358, filed on May 4, 2017.
(60) Provisional application No. 62/544,703, filed on Aug. 11, 2017.

(51) Int. Cl. H04W 74/08; H04W 76/10; H04W 76/27; H04W 72/14

(52) U.S. Cl. CPC H04W 74/0833; H04W 76/10; H04W 88/02; H04W 72/14; H04W 76/27

(57) ABSTRACT

A method of wireless communication by a user equipment (UE) without a radio resource control (RRC) connection to a base station includes receiving system information from the base station and transmitting a data communication to the base station over a control plane without establishing an RRC connection with the base station. A UE in an RRC suspended state may transmit a data communication to the base station over a user plane without resuming an RRC connection with the base station. The data communication may comprise data and UE identity information and/or a cause indication. A base station may indicate resources in the system information for the transmission of the data communication information and receive the data communication over the control plane without establishing an RRC connection with the UE or over a user plane without resuming an RRC connection with an RRC suspended UE.

### CROSS-REFERENCE TO RELATED APPLICATIONS

This application is a continuation-in-part of U.S. application Ser. No. 15/964,523 entitled “Uplink Small Data Transmission For Enhanced Machine-Type-Communication (EMTC) And Internet Of Things (IOT) Communication” and filed on Apr. 27, 2018, which claims the benefit of U.S. Provisional Patent Application No. 62/501,358, entitled “Uplink Small Data Transmission For Enhanced Machine-Type-Communication (EMTC) And Internet Of Things (IOT) Communication,” filed May 4, 2017 and claims the benefit of U.S. Provisional Application Ser. No. 62/544,703, entitled “Uplink Early Data Transmission for Cellular Internet of Things Evolved Packet System” and filed on Aug. 11, 2017, the contents of each of which are expressly incorporated by reference herein in their entirety.

### BACKGROUND

### Technical Field

The present disclosure relates generally to communication systems, and more particularly, to early uplink data transmission for enhanced machine-type-communication (eMTC) and Internet of Things (IoT) communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with IoT), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

A Machine-type-communication (MTC) generally refers to communications that are characterized by automatic data generation, exchange, processing, and actuation among machines with little or no human intervention.

The IoT is the inter-networking of physical devices, vehicles (sometimes referred to as “connected devices” and/or “smart devices”), buildings, and other items that may be embedded with electronics, software, sensors, actuators, and network connectivity that enable these objects to collect and exchange data and other information.

Many MTC and IoT applications may involve relatively infrequent exchange of small amounts of data (e.g., one uplink packet). For example, metering, alarms and etc. are expected to produce a small amount uplink (UL) data. Similarly, queries, notifications of an update, and commands to actuators, for example, generate small downlink (DL) data transmissions.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

When a user equipment is in an idle state, a significant amount of overhead is required in order to setup or resume a radio resource control (RRC) connection. Accordingly, for MTC or IoT applications, there may be a significant expenditure of resources for a small data transmission (e.g. 1 uplink packet or 1 medium access control (MAC) Block). Therefore, it is desirable to minimize the amount of resources used in MTC and IoT communication.

Aspects of the present disclosure are directed to reducing the overhead for setting up or resuming an RRC connection in order to transmit small data transmissions. When an RRC connection of a UE is in an idle state or a suspended state, a significant amount of overhead is required to setup or resume the RRC connection for a data transmission. When the data transmission is for MTC or IoT applications, this may require a significant expenditure of resources for a small data transmission (e.g. 1 medium access control (MAC) Block). For instance, in conventional techniques, numerous communication steps are performed by the UE and/or a base station to establish an RRC connection or resume an RRC connection before data may be transmitted. Furthermore, after the data transmission, additional steps are performed to release the RRC connection. In contrast, aspects of the present disclosure provide for data transmission (e.g., uplink data transmission) from a UE having an RRC connection in an idle state or a suspended state, without transitioning to an RRC connected state. The data transmission without performing an RRC establishment process, or without resuming an RRC connection, may be referred to as early data transmission (EDT) or data transmission in an RRC connectionless mode.

In an aspect of the present disclosure, a method, a computer readable medium, and an apparatus are provided for wireless communication at a User Equipment (UE). The apparatus includes a memory and one or more processors coupled to the memory. The apparatus receives system information from a base station and transmits a data communication to the base station over a control plane without establishing an RRC connection with the base station, wherein the data communication comprises data and at least one of UE identity information and a cause indication.

In another aspect of the present disclosure, a method, a computer readable medium, and an apparatus are provided for wireless communication at a base station. The apparatus includes a memory and one or more processors coupled to the memory. The apparatus indicates resources in system information and receives a data communication from a UE over a control plane without establishing an RRC connection with the UE, wherein the data communication comprises data and at least one of UE identity information and a cause indication.

In another aspect of the present disclosure, a method, a computer readable medium, and an apparatus are provided for wireless communication at a UE, e.g., in an RRC suspended state. The apparatus includes a memory and one or more processors coupled to the memory. The apparatus receives system information from a base station and transmits a data communication to the base station over a user plane without resuming an RRC connection with the base station, wherein the data communication comprises data and at least one of UE identity information and a cause indication.

In an aspect of the present disclosure, a method, a computer readable medium, and an apparatus are provided for wireless communication at a base station. The apparatus includes a memory and one or more processors coupled to the memory. The apparatus indicates resources in system information and receives a data communication from a UE over a user plane without resuming an RRC connection with the UE, wherein the data communication comprises data and at least one of UE identity information and a cause indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating an example of a base station and user equipment (UE).

FIG. 4 is a diagram illustrating an example communication system comprising a base station and UEs.

FIGS. 5 and 6 are example call flow diagrams in accordance with aspects of the present disclosure.

FIG. 7 is a flowchart of a method of wireless communication.

FIG. 8 is a conceptual data flow diagram illustrating the data flow between different means/components in an example apparatus.

FIG. 9 is a diagram illustrating an example of a hardware implementation for an apparatus employing a processing system.

FIG. 10 is a flowchart of a method of wireless communication.

FIG. 11 is a conceptual data flow diagram illustrating the data flow between different means/components in an example apparatus.

FIG. 12 is a diagram illustrating an example of a hardware implementation for an apparatus employing a processing system.

FIG. 13 is a flowchart of a method of wireless communication.

FIG. 14 is a conceptual data flow diagram illustrating the data flow between different means/components in an example apparatus.

FIG. 15 is a diagram illustrating an example of a hardware implementation for an apparatus employing a processing system.

FIG. 16 is a flowchart of a method of wireless communication.

FIG. 17 is a conceptual data flow diagram illustrating the data flow between different means/components in an example apparatus.

FIG. 18 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Aspects of the present disclosure are directed to MTC and /or IoT communications, in which the UE is in an Idle mode or suspend mode at the time when a data transmission is initiated. When the UE is in Idle mode or suspend mode when a data transmission is initiated, conventional techniques perform a full Radio Resource Control Connection establishment procedure prior to the data transmission. Full Radio Resource Control (RRC) Connection establishment procedure for Idle user equipments (UEs) involves a random access (RA) procedure. The RA procedure may be used to initiate a data transfer but has a large overhead cost and latency. For example, in conventional techniques, the RA procedure may include a sequence of messages including Msg1 (physical random access channel PRACH preamble), Msg2 (random access request (RAR)), Msg3 (RRC Connection Request, RRC Connection Re-establishment Request, RRC Connection Resume Request or the like depending on the reason for RA procedure), Msg4 (early contention resolution, RRC Connection Setup etc.), and finally Msg5 which can be used for the UL data (unless SR/BSR is required before actual payload transmission). This involves 5 or more messages for UL data before actual payload transmission. This is a large overhead for applications that transmit uplink data that fits into one transport block size (TBS).

After the RA procedure is completed, a DL/UL transmission may be performed. As such, conventional approaches perform a large number of message exchanges before the actual payload transmission, even for very small and/or infrequent payload.

To address these and other issues, aspects of the present disclosure provide for early uplink data transmission and other enhancements for MTC and/or IoT communications. That is, rather than scheduling the first UL data transmission in Msg 5 or later, as in conventional techniques, the data transmission in the UL may transit data (e.g., payload) in Msg1 or Msg3, for example. In some aspects, the enhancements may be applicable to control plane (CP)/User plane (UP) Cellular IoT Evolved Packet Systems. By providing early uplink data transmission for UEs in Idle or suspend mode for MTC and IoT, power consumption, latency and system overhead may beneficially be reduced.

In one example aspect, the data transmission information may be included in Msg3 and transmitted to a base station (e.g., an eNodeB). As used herein, a data transmission may refer to user data. The transmission of Msg3 may be performed on an initial UL grant provided by a random access request (RAR). The Msg3 may also convey a Non-Access Stratum (NAS) UE identifier for initial access, without a NAS message (e.g., mobility management message). Msg3 transmission may be performed using a separate Msg3 buffer, which may have a higher priority than the UL buffer. Msg3 may use Hybrid Automatic Repeat Requests (HARQ). Additionally, the UE Medium Access Control (MAC) layer includes a HARQ entity and may retransmit a message in case the UE does not receive MAC layer response from the base station. For example, if the UE does not receive Msg4, which could lead to contention resolution failure, the UE (MAC) layer can re-attempt access from an idle state.

As presented herein, the RA procedure may be enhanced to support UL data transmission in Msg3. In one example, the payload (e.g., service data unit (SDU)) may be included as a Common Control Channel (CCCH) SDU.

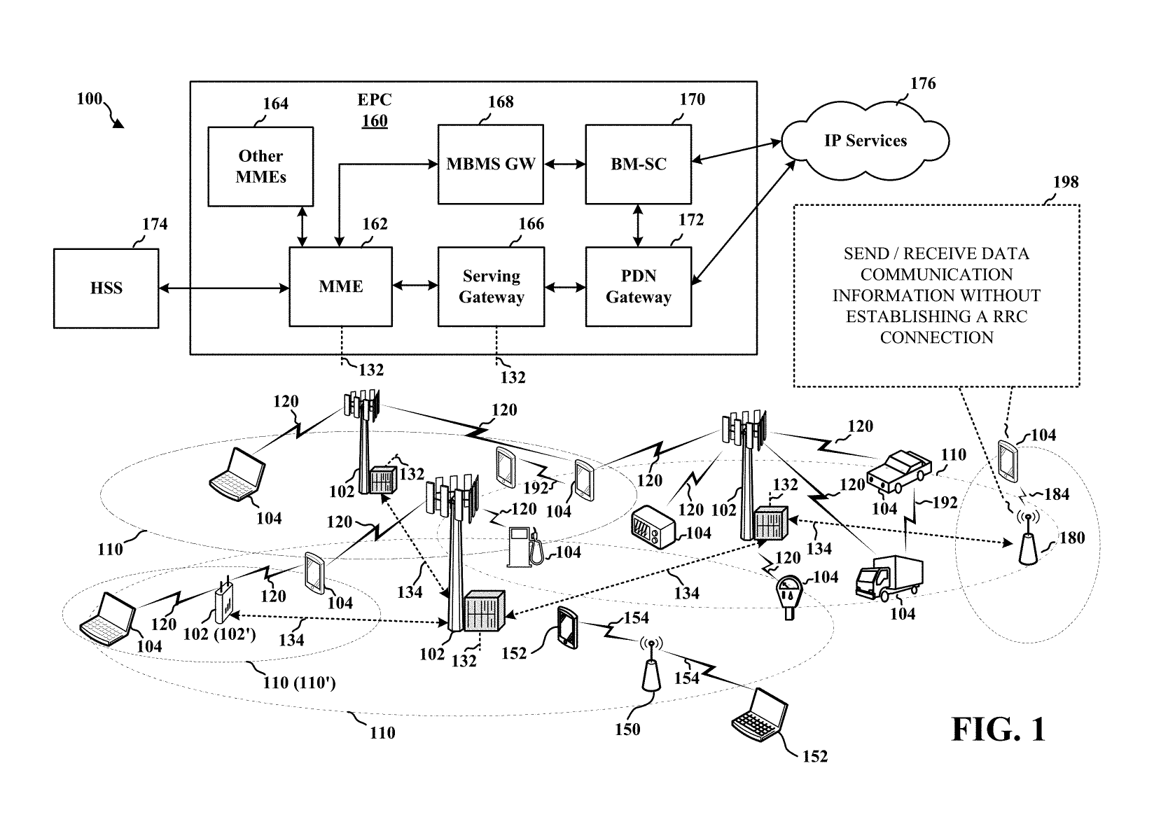

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include UL (also referred to as reverse link) transmissions from a UE 104 to a base station 102 and/or DL (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104/base station 180 may be respectively configured to send and receive data communication information without establishing a RRC connection (198).

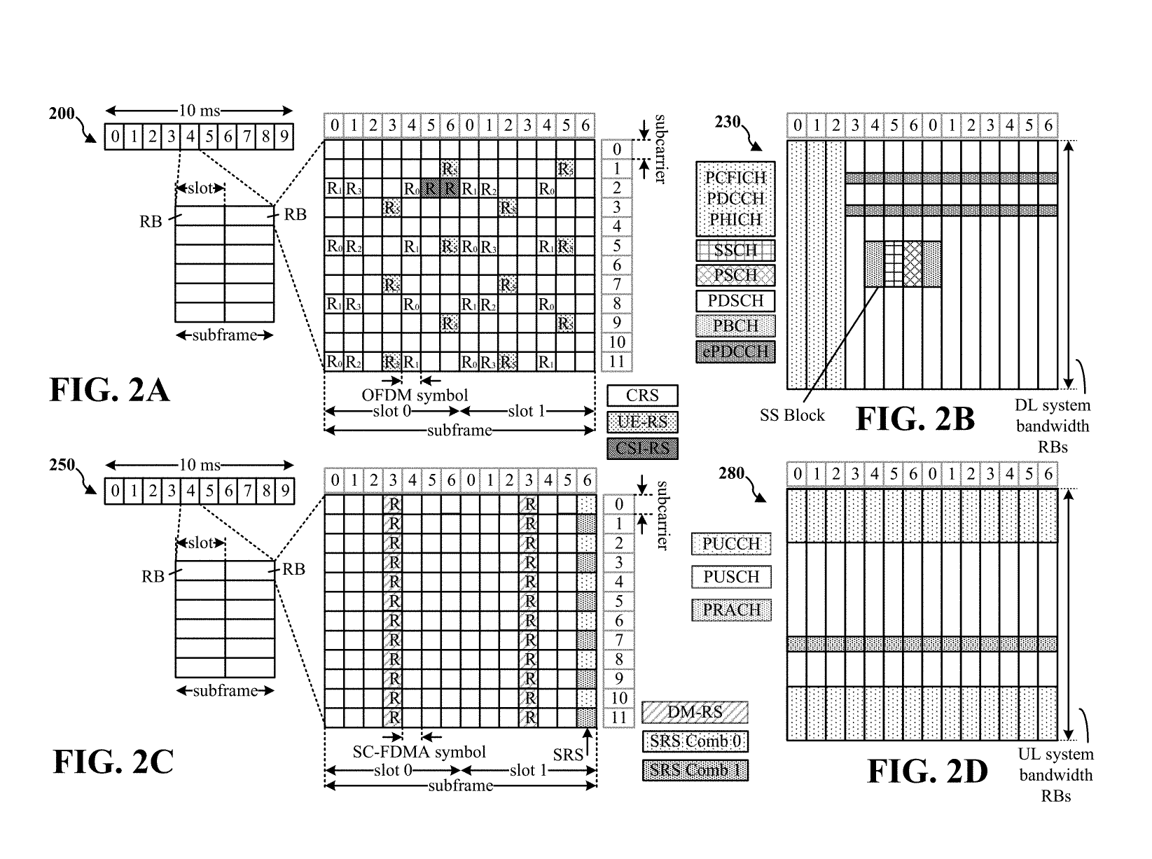

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB may contain 12 consecutive subcarriers in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 104 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

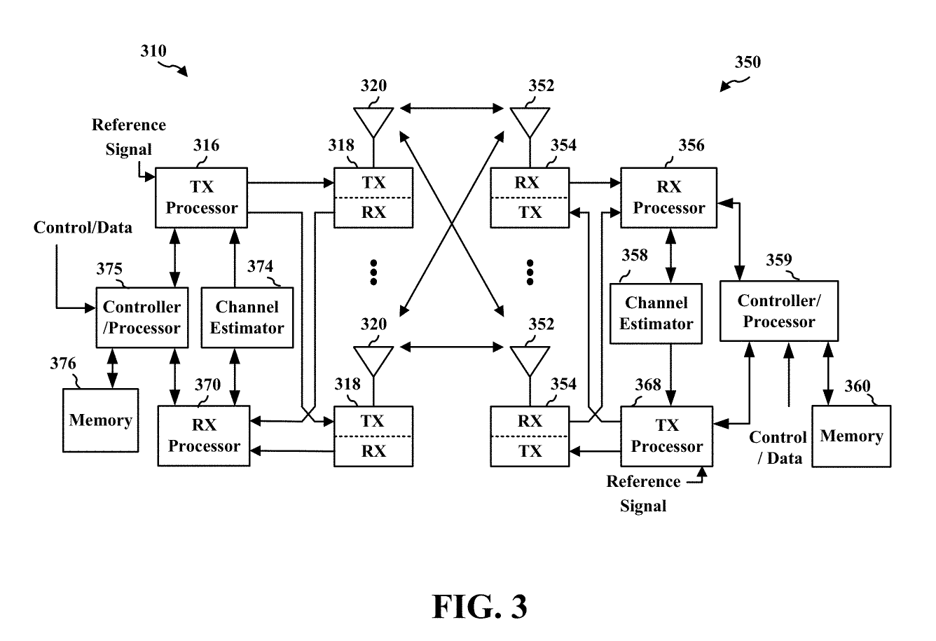

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In one example aspect, one or both of the base station 310 and the UE 350 may have logic, software, firmware, configuration files, etc., to allow the MCT/IoT communications described herein.

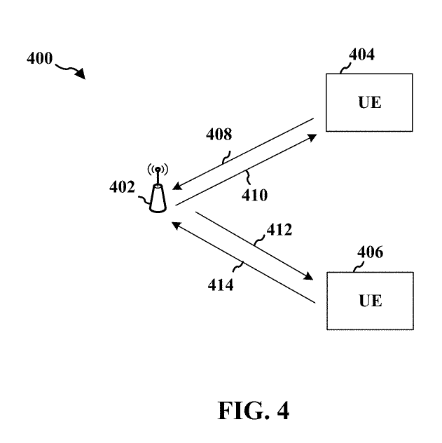

FIG. 4 is a diagram 400 illustrating a communication system in accordance with various aspects of the present disclosure. FIG. 4 includes a node 402 and multiple UEs 404, 406. UE 404 may comprise an MTC UE, IoT UE, a Bandwidth reduced Low complexity (BL) UE, etc. UE 406 may also comprise an MTC UE, IoT UE, or BL UE, or UE 406 may communicate with the base station in a manner different than MTC, IoT, BL. The node 402 can be a macro node (e.g., a base station), femto node, pico node, or similar base station, a mobile base station, a relay, a UE (e.g., communicating in peer-to-peer or ad-hoc mode with another UE), a portion thereof, and/or substantially any component that communicates control data in a wireless network. The UE 404 and UE 406 can each be a mobile terminal, a stationary terminal, a modem (or other tethered device), a portion thereof, and/or substantially any device that receives control data in a wireless network.

As shown in FIG. 4, the UE 404 receives DL transmissions 410 from base station 402 and sends UL transmissions 408 to the base station 402. In one aspect, the DL and UL transmissions 410 and 408 may include either MTC/IoT/BL control information or MTC/IoT/BL data. The UE 406 receives DL transmissions 412 from base station 402 and sends UL transmissions 414 to the base station 402. The communication between UE 404 and base station 402 may include, e.g., cellular IoT (CIoT) Evolved Packet System (EPS) optimization procedures that include early data transmission during a Random Access procedure without transitioning to an RRC connected state. The early data transmission may comprise UL and/or DL data.

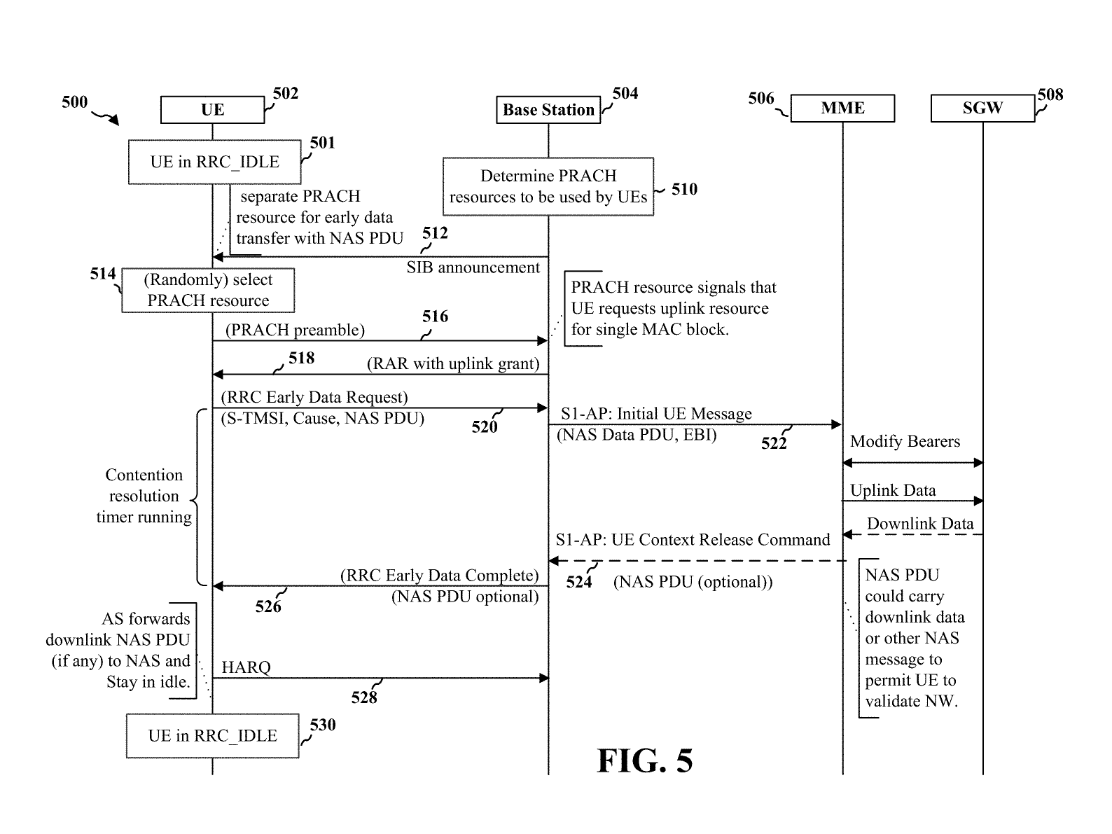

FIG. 5 is an example call flow diagram 500 in accordance with aspects of the present disclosure. Referring to FIG. 5, the call flow diagram 500 illustrates communication between a UE 502, a base station 504, a MME 506, and a SGW 508. The UE 502 may comprise an NB-IoT UE, a BL UE, eMTC UE, or CE UE. In some aspects, the UE 502 may be in an idle state 501 (e.g., RRC Idle). In block 510, a resource determination may be made by base station 504. The base station determines the resources to be used by UE 502 for PRACH attempts. The PRACH resources determined at 510 may comprise PRACH resources associated with early data transmission, e.g., PRACH resources allocated for early data transfer without establishing an RRC connection. For instance, base station may allow transmission of small data packet sizes (e.g., 10 bytes to 50 bytes) without establishing a full RRC connection. For example, the early data transmission may comprise a single data packet. The PRACH resources associated with early data transmission may be different than those allocated by the base station for data transmission after an RRC connection establishment. Additionally, the allocated PRACH resources may be different for different coverage enhancement (CE) levels. Thus, for early data transmission, the UE may select from a PRACH resource set associated with early data transfer for a selected enhanced coverage level.

The enhanced early data transmission (Tx) mode may include transmission of data in Msg1 (e.g., transmission with a RACH preamble) or Msg3 (e.g., transmission following a RAR), whereas other data transmission modes may require the data to be transmitted after RRC connection establishment

The base station 504 may announce the allocated PRACH resources via a system information broadcast (SIB) (512). As illustrated in FIG. 5, the SIB may indicate separate PRACH resources for early data transmission, e.g., data transfer prior to or without an RRC connection establishment. In addition, the SIB announcement may also indicate the transport block size (TBS) that can be used for early data transmission, which may be used by the UE to make determination of whether to use the early data transmission.

In block 514, the UE 502 selects a PRACH/NPRACH resource based on the announced resources in the SIB and the amount of data to be transmitted. In some aspects, the resource selection may be based on a random selection from the corresponding PRACH pool or a dedicated allocation. The UE may indicate an intention to perform an early data transfer to the network (e.g., base station 504) through the UE's selection of the PRACH/NPRACH resources. For example, the UE may select the PRACH resources from the separate pool allocated for enhanced early data transmission when the UE intends to transmit the data prior to/without establishing an RRC connection with the base station. The UE may determine whether to transmit the data using the enhanced early data transmission based on the amount of data to be transmitted to the base station. For example, when the UE has a single uplink packet to transmit to the base station which can be fit into a single MAC block transmission based on the SIB announcement of TBS size, the UE may select from among the PRACH resources allocated for early data transmission. Otherwise, the UE may select from among the other PRACH resources. In another example, the UE may determine whether to perform early data transmission based on a number of bytes of data to be transmitted upon comparison with the information provided in the SIB. The size may be limited to a single MAC block, for example. For example, when the number of bytes is less than 50 bytes, the UE may select from among the PRACH resources allocated for early data transmission. Otherwise, the UE may select from among the other PRACH resources. Thus, the selection of the PRACH resources may be based on the amount of data to be transmitted.

The UE 502 transmits a PRACH preamble 516 using the selected PRACH/NPRACH resources, as a first communication message to the base station 504 (516). The PRACH preamble may be referred to as Msg1, in an example. The PRACH/NPRACH preamble selected by the UE may be based on the PRACH resources associated with early data transmission. In one example, the UE may include data in this first transmission to the base station. For example, the Msg1 may comprise, optionally a PRACH preamble, and a NAS PDU.

The base station 504 sends a RA response (RAR) to the UE (at 518) in the second communication message, including an uplink grant for the UE to perform the early data transmission. The RAR may be referred to as Msg2, in an example. In communication that requires an RRC connection to be established prior to data transmission, the RAR may contain an uplink grant for transmission of RRC connection establishment/reestablishment/resume message. The RAR may also include a timing advance (TA) (in addition to Temporary C-RNTI etc.). To enable early data transmission prior to establishing an RRC connection, the RAR 518 may include uplink grant for early data transmission in addition to, one or more of timing advance, temporary C-RNTI, power control information etc. If the power control information is not included, alternatively, the UE 502 may use open-loop power control in which the UE determines the transmit power.

At 520, the UE 502 may transmit the data to base station using an initial UL grant indicated in the RAR 518. In one example, the message may be referred to as an RRC Early Data Request message. In another example, the message may be referred to as an RRC Connectionless Request. The payload may be included in the message 520 on CCCH, e.g., as a CCCH SDU. The data may be transmitted as a NAS protocol data unit (PDU) over the control plane. The transmission at 520 is performed during the random access procedure and without establishing an RRC connection. The transmission 520 is illustrated as the third communication message to the base station 504, and may be referred to as Msg3. The transmission 520 may further comprise a UE identification (UEID). In some aspects, the UEID may comprise a temporary mobile subscriber identity (e.g., a System Architecture Evolution TMSI (S-TMSI)). In some aspects, if the UE has been previously suspended, the UEID may comprise a Resume ID. As illustrated in FIG. 5, the message 520 may also include an indication of a cause. The cause may indicate an RRC connectionless mode. The cause may be referred to as a “cause code,” and a code included in the message may indicate whether the message 520 comprises data for transmission in an RRC connectionless mode. The indication of the cause may also be referred to as an establishment cause. The UE 502 may take into account the power control information from the RAR, if included in the RAR. The UE 502 may start a contention resolution timer after this step. For example, the contention resolution timer may be implemented using the controller/processor 359 in the example UE 350 of FIG. 3. The contention resolution timer value for early data transmission may be different compared to the contention resolution timer value for the communication that requires an RRC connection to be established prior to data transmission.

The message 520 may comprise data stored in a separate early data transmission buffer, e.g., which may be referred to as a Msg3 buffer. This buffer may have a higher priority than an UL buffer for transmission after an RRC connection.

In some aspects, the message 520 may further include an indication regarding the RRC connectionless early UL data transmission. The indication may enable the base station 504 to differentiate a UE requesting the early data transmission before or after RRC connection establishment. As a result, the base station 504 may provide an additional message comprising a fast UL grant for connectionless UL transmission (e.g., providing an UL grant to the UE without the UE transitioning to RRC connected state). The UE may then respond with the data transfer without transitioning to the RRC connected state.

Further, in some aspects, the message 520 may include the NAS PDU, as well as an indication that further UL data is pending at the UE. As such, the base station may respond to the message by providing further UL grants for transmission using the RRC connectionless mode.

At 522, the base station selects the MME 506 based on the UE identifying information (e.g., S-TMSI) in the message 520 and forwards the NAS PDU to the MME 506. The base station 504 may also provide MME 506 an indication that there is only one uplink NAS PDU. This may be done, for example, by including a cause code (e.g., “RRC Connectionless Mode”) in the message 522 to the MME.

At 524, if DL data is available for the UE 502, the SGW 508 provides the DL data to the MME 506, which forwards the DL data as NAS PDU to the base station 504 to be delivered to UE 502. If the base station 504 has indicated that there is only one UL NAS PDU, in response, the MME 506 may close the S1 application protocol (S1-AP) connection after forwarding any downlink NAS PDU. As illustrated, the message 524 may comprise the DL NAS PDU and the release command. Further, the base station indication of one UL NAS PDU may also be used by MME 506 to prioritize processing of the UL data and expedite or prioritize the transmission of DL data by SGW 508 to the MME 506.

At 526, the base station 504 may transmit a message confirming reception of the data in message 520. In one example, the message 526 may be called an RRC Early Data Complete message. In another example, the message may be called an RRC Connectionless Confirm message. This message may comprise a fourth message between the UE and base station and may be referred to as Msg4, in some examples. If a UE 502 receives message 526, it may consider the early data transmission to be successfully completed and consider the contention is resolved. The message 526 may include a DL NAS PDU. If NAS PDU is included, the NAS may confirm that it is communicating with a valid network. If DL data is included in message 526, the UE may respond with HARQ 528 to include reception of the DL data. The UE may retransmit the message 520 if the UE does not receive a response, e.g., a MAC level response, from the base station. The failure to receive a response within the contention resolution timer indicates a contention resolution failure leading the UE to re-attempt access from the idle state. If there is no DL data for the UE, then the message 526 may merely provide a confirmation that the UL data was received. Following message 526 or message 528, the UE may continue in an RRC idle state 530. Thus, the UL data may be transmitted, e.g., at 516 or 520 during the random access procedure, without establishing an RRC connection and without the UE transitioning to an RRC connected state.

In some aspects, message 524 may be missing (e.g., the base station sends data to MME 506, but MME 506 does not respond for certain reasons). In such a case, the base station 504 may, for example, start a timer after message 522. Upon the expiration of the timer, the base station 504 may proceed to message 526 with a positive ACK of successful reception of message 520. In another example, the base station 504 may start a timer after message 522. Upon the expiration of such timer, the base station 504 may proceeds to message 526 with a positive ACK of successful reception of the message 520 with a further indication that the base station 504 has failed to receive an ACK from MME 506. In this example, the absence of the NAS PDU in message 524 may be indicated to upper layers of the protocol stack by the UE 502. The UE returns to idle, at 530.

Further, in some aspects, in message 524, the MME 506, instead of or in addition to confirming the reception of NAS PDU from the base station 504, may indicate that the UE 502 is to transition to RRC connected state from idle state instead of completing the RRC connectionless transmission session. In such a case, S1-AP may not be closed immediately and the base station in message 526 may send an indication to the UE 502 to transition to RRC connected state (e.g., RRC Connection Setup).

In the example call flow 500, a dedicated radio bearer (DRB), as well as the packet data convergence protocol (PDCP) layer and radio link control layer RLC are not established for the early data transmission. This is because the early data transmission may be performed without establishing an RRC connection and instead using control plane RRC messaging. As such, the UE 502 remains in RRC_IDLE state.

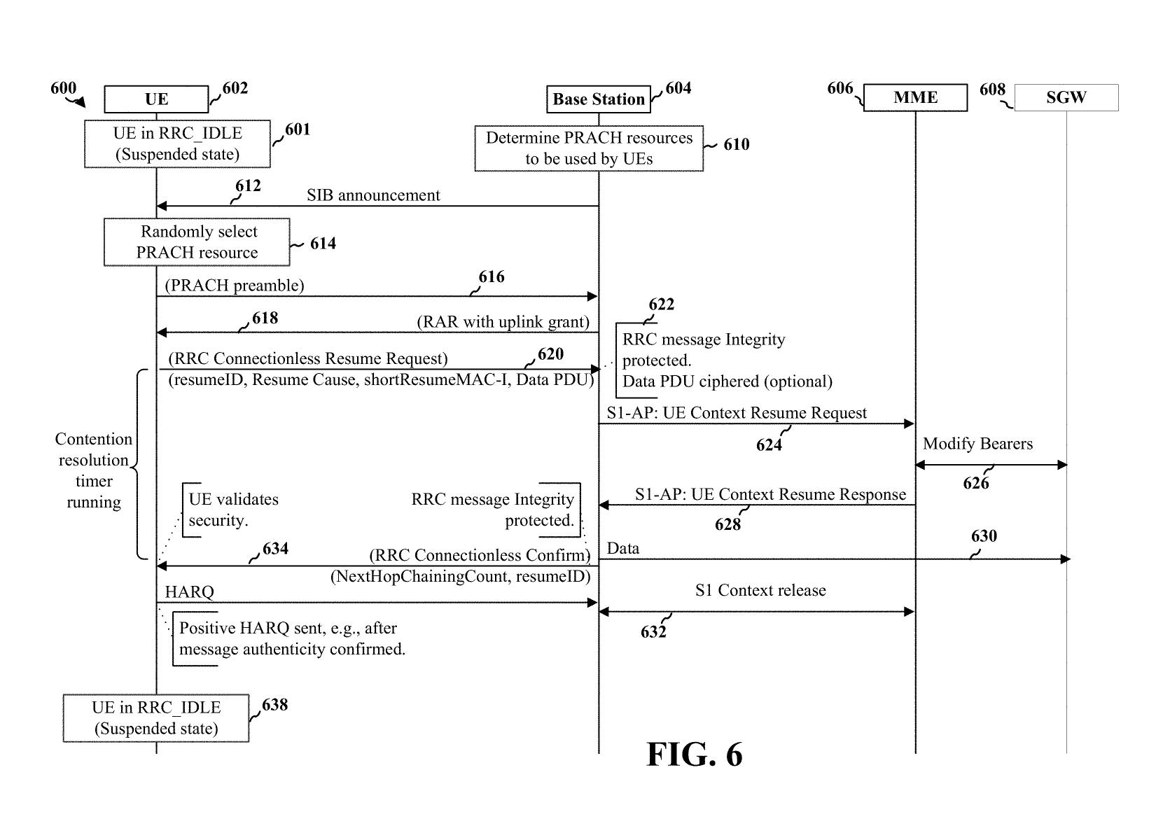

FIG. 6 is an example call flow diagram 600 in accordance with aspects of the present disclosure. Referring to FIG. 6, the call flow diagram 600 illustrates communication between a UE 602, a base station 604, a MME 606, and a SGW 608. The UE 602 may comprise an NB-IoT UE, a BL UE, eMTC UE, or CE UE. In some aspects, the UE 602 may be in an idle state 601 (e.g., an RRC suspended state). In block 610, a resource determination may be made by the base station. The determination may be similar to that described in connection with 510 in FIG. 5. For instance, base station 604 may allow transmission of small data packet sizes (e.g., 10 bytes to 50 bytes) without establishing a full RRC connection, e.g., during random access without the UE transitioning from the RRC suspended state to an RRC connected state. The data transmission in FIG. 6 may be performed over a user plane, whereas the data transmission in FIG. 5 may be performed over a control plane. The base station may determine the resources to be used by UE 602 for PRACH attempts. In some aspects, the base station 604 may allocate PRACH resources for this purpose. The PRACH resources determined at 610 may comprise PRACH resources associated with enhanced early data transmission, e.g., PRACH resources allocated for data transfer prior to or without an RRC connection establishment. The PRACH resources allocated for early data transmission may be different than those allocated by the base station for data transmission after an RRC connection establishment. Additionally, the allocated PRACH resources may be different for different CE levels. Thus, for early data transmission, the UE may select from a PRACH resource set associated with early data transfer for a selected enhanced coverage level.

In some aspects, the enhanced early data transmission may include transmission of data in Msg1 (e.g., with a RACH preamble) or in Msg3 (e.g., a transmission following a RAR) rather than being transmitted after completion of RRC connection resume. The UE may indicate an intention to perform an early data transmission without resumption of RRC connection to the network (e.g., base station 604) by selecting the PRACH/NPRACH resources from a separate pool allocated for such RRC connectionless early data transfer. The base station 604 may announce the pool of resources via a system information broadcast (SIB) (612).

In block 614, the UE 602 selects a PRACH/NPRACH resource based on the announced resources in the SIB and the amount of data to be transmitted. For example, if the size of the data to be transmitted meets a size limit received from the base station, then the UE may select a PRACH/NPRACH resource from the pool associated with early data transfer. As described in connection with the example in FIG. 5, the UE may determine whether to transmit the uplink data using an RRC connectionless early data transmission based on the amount of data to be transmitted. Thus, if the size of the data is beyond the limit, then the UE may select different PRACH/NPRACH resources for performing random access. In some aspects, the resource selection may be based on a random selection from the corresponding PRACH pool or a dedicated allocation.

The UE 602 transmits the selected PRACH/NPRACH preamble in a first communication message to the base station 604 (616). The first communication message may be referred to as Msg1, and may initiate an early data transmission. The PRACH/NPRACH preamble selected by the UE may be based on the PRACH resources associated with early data transmission. In one example, data for early transmission may be included in this first message to the base station.

The base station 604 sends an RAR to the UE (at 618) in a second communication message (e.g., that may be referred to as Msg2). The RAR may contain an uplink grant for early data transmission. The RAR may also include timing advance (in addition to Temporary C-RNTI etc.). To enable transmission of data without resumption of an RRC connection by the UE 502, the RAR may also include power control information. Alternatively, the UE 502 may use open-loop power control (e.g., the UE decides on the transmit power).

At 620, the UE 602 may transmit data to the base station based on the uplink grant indicated in the RAR 618. The data may be included in the message 620 on CCCH. The message 620 may be a third communication message to the base station and may be referred to as Msg3. The data may be transmitted as a data PDU over the user plane. The transmission at 620 may be performed during the random access procedure and without resuming previously suspended RRC connection. The message 620 may include a UE identifier. As the UE is in an RRC suspended state 601, the UE identifier may include the UE's resume ID. As the UE 602 has been previously suspended, Msg3 may comprise of a message similar to an RRCConnectionResumeRequest comprising the UE's Resume ID and including application data. The message may also indicate a cause, e.g., indicating early data transmission as a cause for the message. This indication of the cause may be referred to as a “resume cause” or an “establishment cause.” For example, only a subset of the cause values may be applicable for early data transmission. Alternatively, a new resume cause value may be defined for the early transmission of data in message 620. If this new cause value is signaled, the base station may forward the data to the MME 606 without resuming RRC. Alternatively, a new message may be defined to carry a combination of unciphered and ciphered payload.

The UE 602 may apply security to data PDU carried by message 620. Thus, the message 620 may also include an authentication token. FIG. 6 illustrates the message including an example authentication token called shortResumeMAC-I. The authentication token may also be referred to by other names. Integrity may also be applied to the entire message 620. While being in RRC suspended state, the UE 602 stores security keys to use for integrity which can be resumed to be used. In some aspects, the UE 602 may also have stored keys for ciphering. Thus, user data both on the uplink and the downlink may be ciphered. The UE 602 may be provided with a NextHopChainingCount as well as resumeID during suspension, e.g., at 601 from previous session or in 634 of current session to be used for next session.

In some aspects, a copy of the PDU (e.g. data) may be left in the PDCP stack for possible repeat transmission attempts in the event of a transmission failure of message 620.

The UE 602 may also use security parameters based (at 620) on the NextHopChainingCount provided during last suspension, e.g., in an RRC connection release message from the previous RRC connection. Thus, the data may be ciphered based on a count, such as the NextHopChainingCount. The UE 602 may cipher data PDU and compute an integrity key (e.g., over entire RRC Connectionless Resume Request message). In some aspects, the eNodeB base key (KeNB), integrity key for RRC signaling (KRRCint), encryption key for RRC (KRRCenc) or other security parameters may be used for MAC calculation and optional ciphering, for example. The security parameters may be based on information previously provided to the UE, e.g., during the previous suspension. The resumeID, resumeCause and shortResumeMAC-I may be transmitted without ciphering.

At block 622, the base station 604 optionally decodes the RRC message, fetches UE context and verifies integrity. If the integrity is successfully verified, then the base station deciphers the data.

At 624, the base station transmits S1-AP UE context resume request to the MME 606, which triggers MME 606 to resume the suspended connection. Thus, the base station initiates the S1-AP context resume procedure to resume the S1 user plane external interface (S1-U) bearers. In some aspects, the base station 604 may signal to the MME 606 that there is only one uplink NAS PDU. This may be done, for example, by including a cause code e.g., “RRC Connectionless Mode”. This indication may also be used by the MME 606 to prioritize processing of the UL data and expedite or prioritize sending confirmation of the resume. The MME 606 configures/resumes bearers at 626, e.g., requesting the S-GW to reactivate the S1-U bearers for the UE. At 628, the MME transmits a S1-AP UE context resume response to the base station 604 to confirm the configuration and resuming of the bearers, e.g., to confirm the UE context resumption to the base station.

In some aspects, the UE context may retrievable/unable to resume (e.g., the base station is a new base station and there is no X2 interface). As, such, the MME 606 may indicate failure in the context resume response at 628.

In some aspects, the UE context resume response may be missing (e.g., base station 604 sends UE context resume request to the MME but MME does not respond for various reasons. In such cases, UE 602 may resume to full RRC connection by the base station 604 sending an indication to establish/resume RRC connection.

At 630, the base station forwards data PDU to the SGW 608. Similar to the example described in connection with FIG. 5, if downlink data is available for the UE, the S-GW may send the downlink data to the base station after receiving the uplink data at 630. As illustrated in FIG. 6, the early data transmission may comprise a single uplink data transmission, e.g., 620. As well, the early data transmission may comprise a single downlink data transmission, described in connection with FIG. 6.

If there is only one UL NAS PDU, the S1 context may be released after the data has been forwarded, at 632. For example, when no further data is expected, the S1 connection can be suspended and the S1 -U bearers can be deactivated. The UE may return to the RRC idle, suspended state. As illustrated, the base station may send a message 634 that indicates that the early data transmission is finished and the UE can return to the RRC idle, suspended state 638. The message 634 may comprise a contention resolution message. The message 634 may be integrity protected and may include a count, such as a next hop chaining count, and a resume ID for the UE. The order of messages 630 and 634 may be adjusted so that the confirmation message 634 is sent to the UE prior to the base station forwarding the data 630 to the SGW.

In some aspects, the UE 602 may transmit a HARQ after Access Stratum (AS) security has been passed for the received AS message.

In some aspects, the MME 606, instead of or in addition to confirming the reception of NAS PDU from the base station 604, may indicate that the UE 602 is to transition to RRC connected state from idle state instead of completing a RRC connectionless transmission session. In such case, S1 context may not be released may not be closed immediately and the base station may send an indication to the UE 602 to transition to RRC connected state (e.g., RRC Connection Setup).

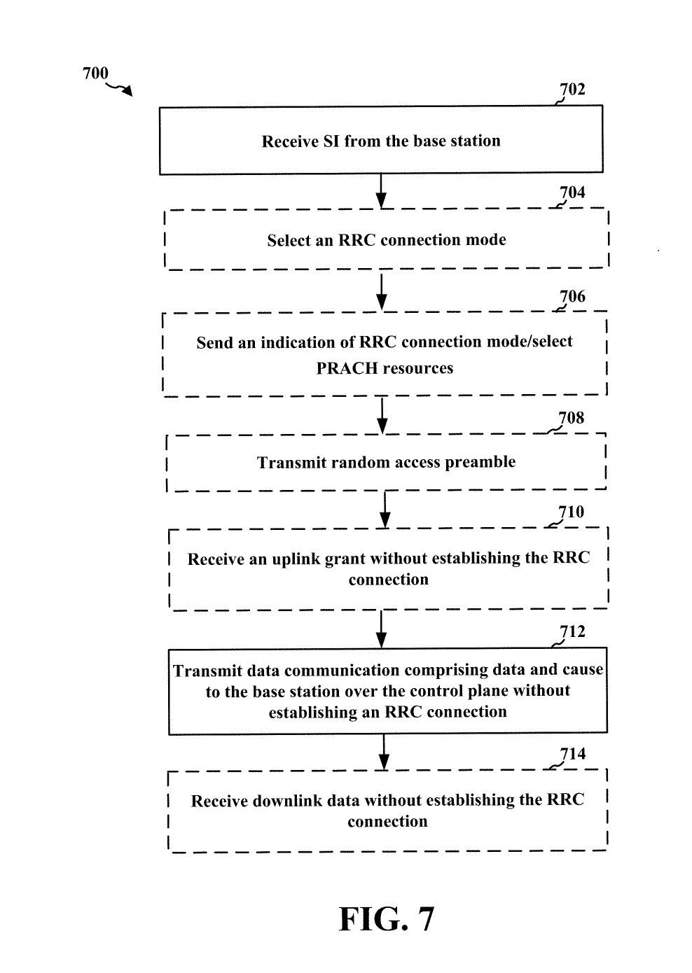

FIG. 7 is a flowchart 700 of a method of wireless communication for early data transmission without an RRC connection to a base station. The UE may be in RRC idle state, as described in connection with FIG. 5. Optional aspects are illustrated with a dashed line. The method may be performed by a UE (e.g., the UE 104, 350, 502, 602, the apparatus 802/802′). The UE may comprise an NB-IoT UE, a BL UE, eMTC UE, or CE UE.

At 702, the UE receives SI from the base station. FIGS. 5 and 6 illustrate examples of SI 512, 612 received by a UE. The SI may indicate PRACH resources to the UE. The PRACH resources may include a set of PRACH resources for early data transmission, e.g., data that is transmitted without establishing an RRC connection. The SI may also indicate the maximum size of UL data that can be transmitted by using early data transmission. The indications can be separate corresponding to different CE levels of different NPRACH resources.

As illustrated at 704, the UE may select an RRC connection mode to transmit the data communication, e.g., selecting between an active RRC connection transmission mode and an RRC connectionless transmission mode. The selection may be based on any of a number of factors, including the size of the data to be transmitted. The UE may send an indication of an RRC connection mode for sending the data communication to the base station, at 706. The indication may comprise a selection of a PRACH resource from a pool of PRACH resources associated with early data transfer. The PRACH resource may comprise a NPRACH. The selected PRACH resources may also indicate an intention to perform a connectionless early data transmission. The SI may be broadcast from the base station and may indicate PRACH resources associated early data transmission without the UE transitioning to an RRC connected state. The UE may select a resource based at least in part on an amount of data to be transmitted in the data communication.

The data communication may be transmitted to the base station during a random access procedure in which the UE does not establish the RRC connection. At 708, the UE may transmit a random access preamble to the base station. The random access preamble may be based on the selection at 706 from amount PRACH resources associated with early data transfer. The UE may receive a grant for an uplink transmission without establishing the RRC connection, at 710.

At 712, the UE transmits a data communication to the base station over a control plane without establishing the RRC connection with the base station. The data communication may be transmitted to the base station, at 712, based on the grant received at 710. The data communication comprises data and a cause indication for the data communication. In some aspects, the cause indication may inform the base station to receive the data communication comprised in message without establishing an RRC connection. For example, the cause indication may be referred to as a cause code, an establishment cause, etc. In some aspects, the cause indication may indicate to the base station that the UE intends to perform an early data transmission without establishing an RRC connection. The data communication may be transmitted on a CCCH, e.g., in a NAS message. Thus, the data communication may be transmitted to the base station without the UE transitioning to an RRC connected state. The data communication may comprise a single uplink data transmission. A size of the data comprised in the single uplink data transmission may less than a size limit indicated by the base station. The data may comprise a NAS PDU transmitted over a control plane, as described in connection with FIG. 5.

The data communication may further comprise UE identity information, e.g., an S-TMSI for the UE.

The early data transfer may further include a small amount of downlink data received from the network. Thus, at 714, the UE may receive a downlink data communication from the base station over the control plane without establishing the RRC connection with the base station. The downlink data communication may be received in an RRC message indicating that an early data transfer is complete. The UE may receive a single downlink data transmission, e.g., as illustrated in FIG. 5. Additional aspects described in connection with either of FIG. 5 or 6 may be performed by the UE in connection with the method of FIG. 7. The UE may continue in an RRC idle state after transmitting and/or receiving the early data transmission.

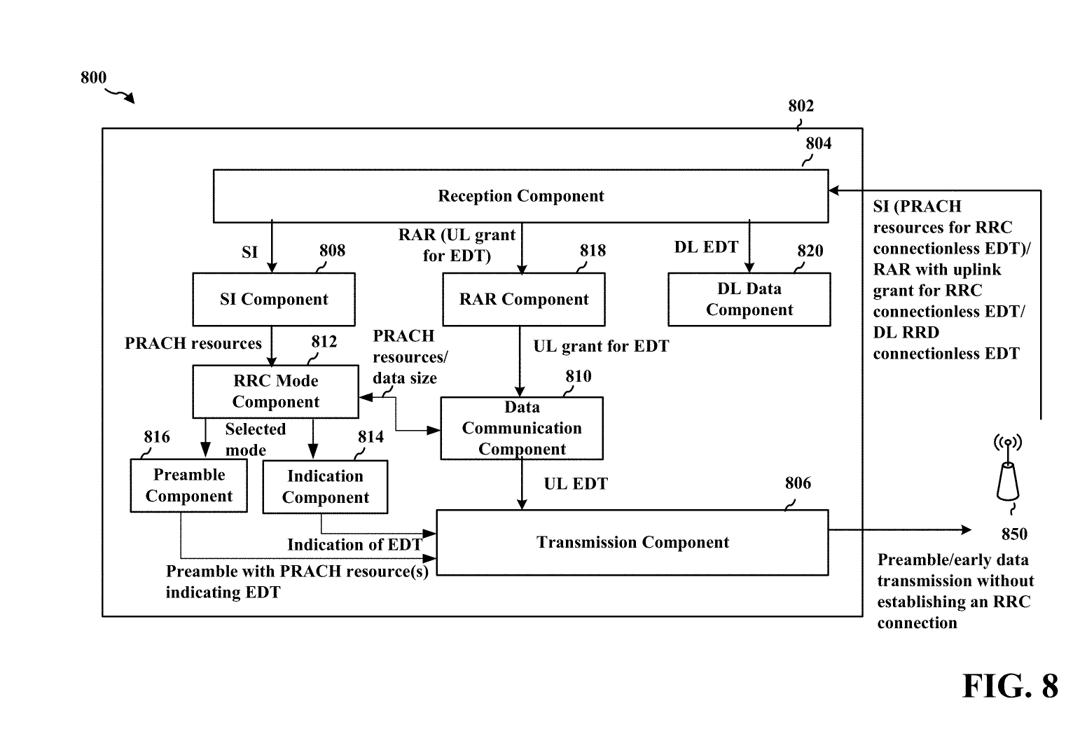

FIG. 8 is a conceptual data flow diagram 800 illustrating the data flow between different means/components in an example apparatus 802. The apparatus may be a UE (e.g., UE 104, 350, 502, 602). The UE may comprise an NB-IoT UE, a BL UE, eMTC UE, or CE UE, etc. The apparatus includes a reception component 804 for receiving downlink communication from a base station 850 and a transmission component 806 for transmitting uplink communication to the base station 850. The apparatus includes a system information component 808 for receiving system information from the base station 850 and a data communication component 810 for transmitting a data communication to the base station over a control plane without establishing the RRC connection with the base station, wherein the data communication comprises data and a cause indication for the data communication. The apparatus may include an RRC mode component 812 for selecting an RRC connection mode to transmit the data communication and an indication component 814 for sending an indication of a RRC connection mode for sending the data communication to the base station. The indication may be based on PRACH resources associated with early data transfer. The apparatus may include a preamble component 816 for transmitting a random access preamble to the base station. The apparatus may include a RAR component 818 for receiving a RAR from the base state, which may include a grant for an uplink transmission without establishing the RRC connection. The apparatus may include a downlink data component 820 for receiving a downlink data communication from the base station over the control plane without establishing the RRC connection with the base station.

The apparatus may include additional components that perform each of the blocks of the algorithm in the aforementioned flowcharts of FIGS. 5, 6, and 7. As such, each block in the aforementioned flowcharts of FIGS. 5, 6, and 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

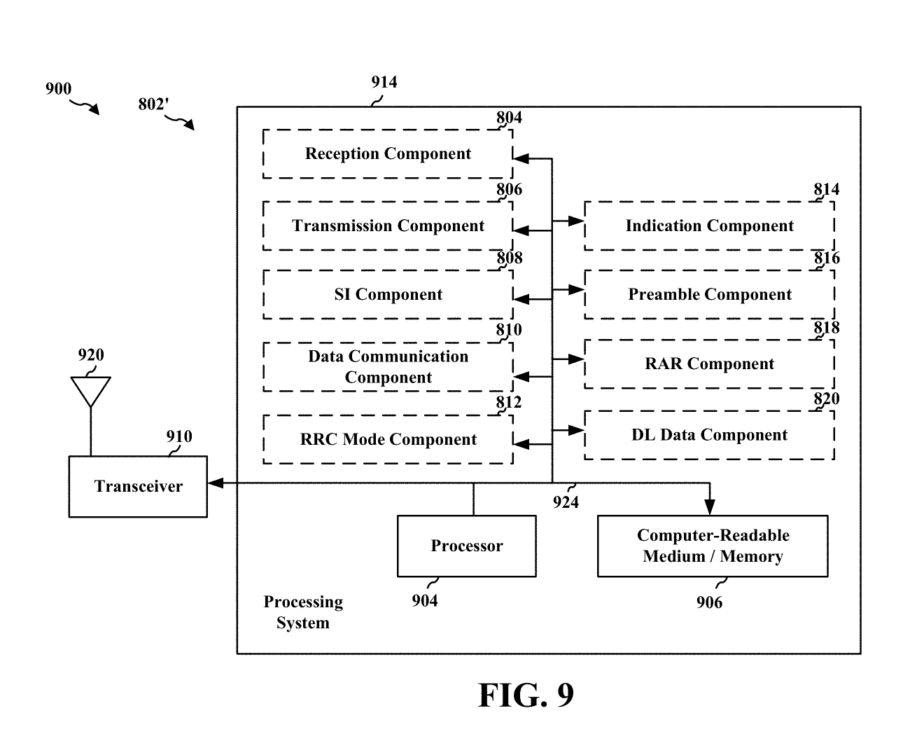

FIG. 9 is a diagram 900 illustrating an example of a hardware implementation for an apparatus 902′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, 814, 816, 818, 820 and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 810, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812, 814, 816, 818, 820. The components may be software components running in the processor 904, resident/stored in the computer readable medium/memory 906, one or more hardware components coupled to the processor 904, or some combination thereof. The processing system 914 may be a component of the base station 310 and may include the memory 376 and/or at least one of the TX processor 316, the RX processor 370, and the controller/processor 375. The processing system 914 may be a component of the UE 350 and may include the memory 360 and/or at least one of the TX processor 368, the RX processor 356, and the controller/processor 359.

In one configuration, the apparatus 802/802′ for wireless communication includes means for receiving system information from the base station; means for transmitting a data communication to the base station over a control plane without establishing the RRC connection with the base station, wherein the data communication comprises data and a cause indication for the data communication, means for selecting an RRC connection mode to transmit the data communication, means for sending an indication of a RRC connection mode for sending the data communication to the base station, means for transmitting a random access preamble to the base station, means for receiving a grant for an uplink transmission without establishing the RRC connection, wherein the data communication is transmitted to the base station based on the grant, and means for receiving a downlink data communication from the base station without establishing the RRC connection with the base station. The aforementioned means may be one or more of the aforementioned components of the apparatus 802 and/or the processing system 914 of the apparatus 802′ configured to perform the functions recited by the aforementioned means. As described supra, the processing system 914 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

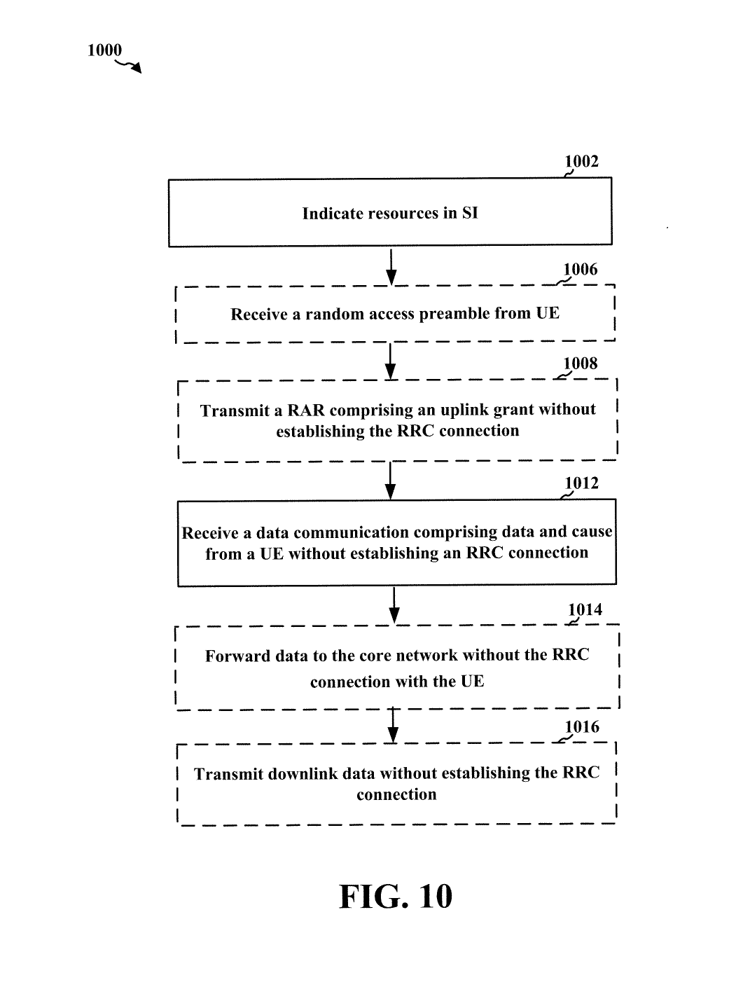

FIG. 10 is a flowchart 1000 of a method of wireless communication for early data reception without an RRC connection to a UE. The method may be performed by a base station (e.g., base station 102, 180, 310, 504, 604, 850, the apparatus 1102, 1102′). Optional aspects are illustrated with a dashed line.

At 1002, the base station indicates resources in system information. FIGS. 5 and 6 illustrate examples of SI 512, 612 transmitted by a base station. The SI may indicate PRACH resources to the UE. The PRACH resources may include a set of PRACH resources for early data transmission, e.g., data that is transmitted without establishing an RRC connection. The SI may also indicate the maximum size of UL data that can be transmitted by using early data transmission. The indications can be separate corresponding to different CE levels of different NPRACH resources.

At 1012, the base station receives a data communication from the UE without establishing the RRC connection with the UE, wherein the data communication comprises data and a cause indication. The cause indication may inform the base station to receive the data communication comprised in the RRC connection resume message without resuming the RRC connection. For example, the cause indication may be referred to as a cause code, an establishment cause, etc. The cause indication may indicate to the base station that the UE intends to perform an early data transmission without establishing an RRC connection. The data communication may be comprised in an RRC message indicating an intention to perform a connectionless early data transmission. The data communication may be received on a CCCH, e.g., in a NAS message. Thus, the data communication may be received from the UE and forwarded to a core network component, at 1014, without establishing an RRC connected state with the UE, e.g., without the UE transitioning to an RRC connected state. The data communication may comprise a single uplink data transmission. The data may comprise a NAS PDU received over a control plane, as described in connection with FIG. 5. The data may comprise a Data PDU received over a user plane, as described in connection with FIG. 6.

The data communication may further comprise UE identity information, e.g., an S-TMSI when the data is received over a control plane or a resume ID for the UE when the data is received over a user plane. The data communication may further comprise an authentication token, e.g., when the data is received over a user plane. The data may be received over the user plane, e.g., when a UE begins from an RRC idle, suspended state. In this example, the data communication may be received in an RRC connection resume message and the cause indication may inform the base station to receive the data communication comprised in the RRC connection resume message without resuming the RRC connection. The data communication may further comprise an authentication token.

The data communication may be received from the UE during a random access procedure, as illustrated in the examples in FIGS. 5 and 6. For example, at 1006, the base station may receive a random access preamble from the UE based on the PRACH resources (e.g., NPRACH resources) associated with early data transfer. Different resources may be associated with different CE levels. In response, the base station may transmit a RAR to the UE, at 1008, the RAR comprising an uplink grant for an early data transmission without establishing the RRC connection with the UE. Then, the data communication may be received, at 1012 from the UE based on the uplink grant.

The early data transfer may further include a small amount of downlink data transmitted to the UE. Thus, at 1016, the base station may transmit a downlink data communication from the base station without establishing the RRC connection with the UE. The downlink data communication may be transmitted to the UE in an RRC message indicating to the UE that an early data transfer is complete. The base station may transmit a single downlink data transmission, e.g., as illustrated in FIG. 5. Additional aspects described in connection with either of FIG. 5 or 6 may be performed by the base station in connection with the method of FIG. 10.

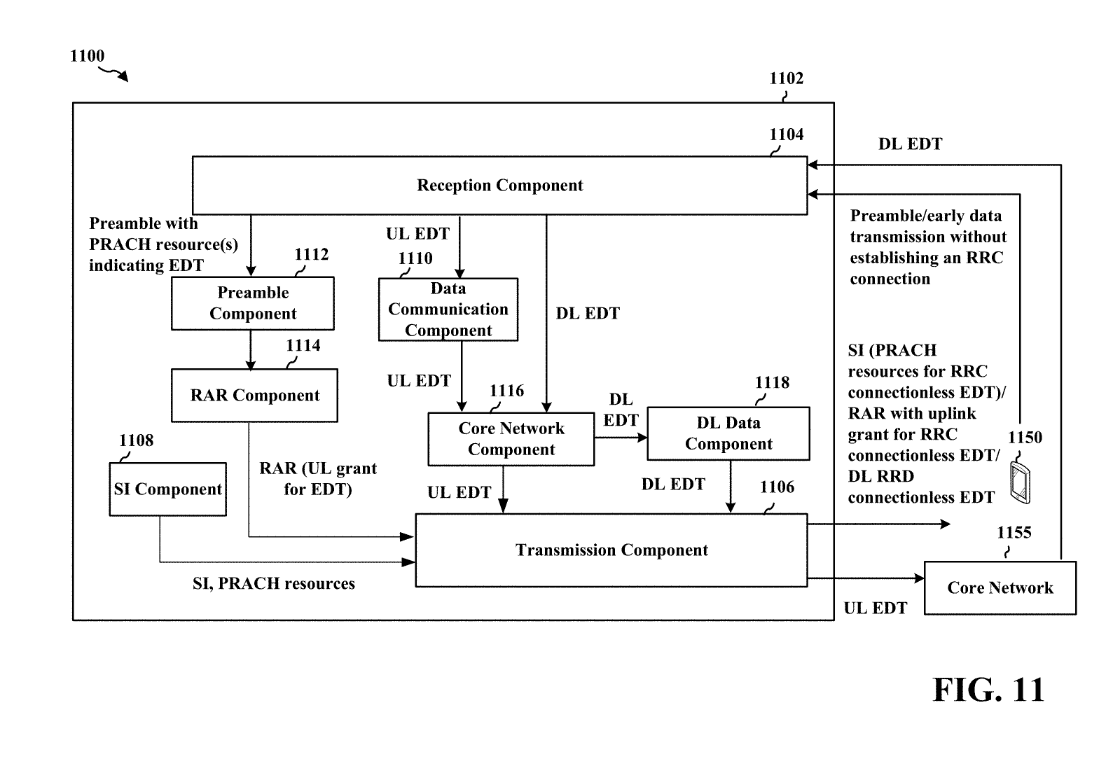

FIG. 11 is a conceptual data flow diagram 1100 illustrating the data flow between different means/components in an exemplary apparatus 1102. The apparatus may be a base station (e.g., base station 102, 180, 310, 504, 604, 850). The apparatus includes a reception component 1104 for receiving uplink communication from UE 1150 and a downlink component 1106 for transmitting downlink communication to UE and/or for communicating with a core network 1155. The apparatus includes an SI component 1108 for indicating resources in system information and a data communication component 1110 for receiving a data communication from the UE without establishing the RRC connection with the UE, wherein the data communication comprises data and a cause indication. The apparatus may include a preamble component 1112 for receiving a random access preamble from the UE based on the PRACH resources associated with early data transfer, and a RAR component 1114 for transmitting a random access response to the UE comprising an uplink grant for an early data transmission without establishing the RRC connection with the UE. The apparatus may include a core network component 1116 for forwarding the data to a core network without establishing the RRC connection with the UE. The apparatus may include a downlink data component 1118 for transmitting a downlink data communication to the UE without establishing the RRC connection with the UE.

The apparatus may include additional components that perform each of the blocks of the algorithm in the aforementioned flowcharts of FIGS. 5, 6, and 10. As such, each block in the aforementioned flowcharts of FIGS. 5, 6, and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

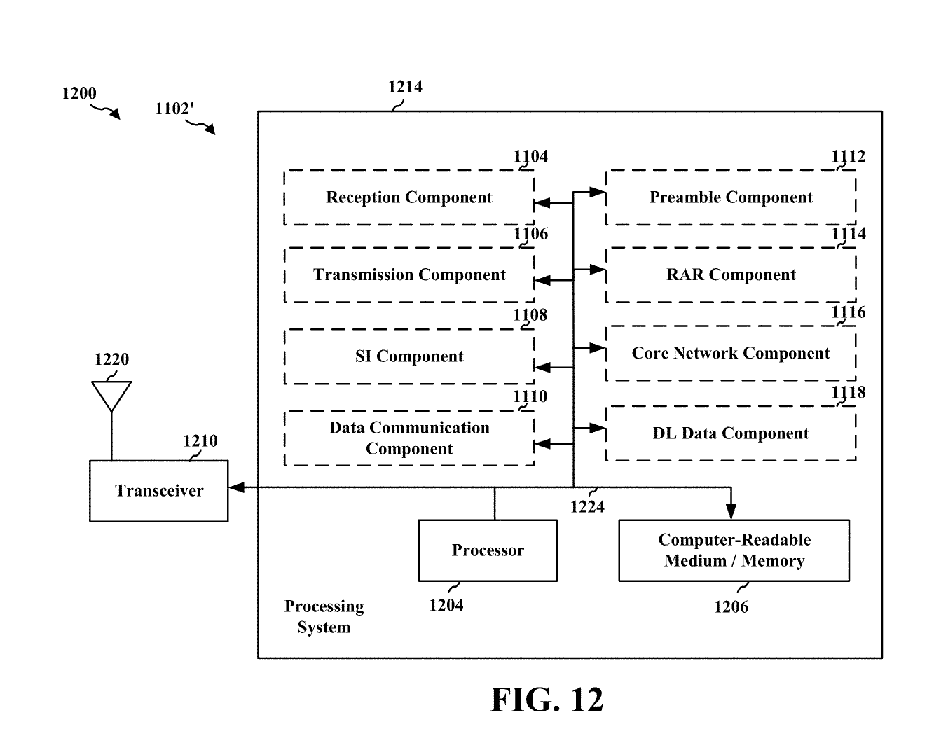

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, 1112, 1114, 1116, 1118, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1106, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108, 1110, 1112, 1114, 1116, 1118. The components may be software components running in the processor 1204, resident/stored in the computer readable medium/memory 1206, one or more hardware components coupled to the processor 1204, or some combination thereof. The processing system 1214 may be a component of the base station 310 and may include the memory 376 and/or at least one of the TX processor 316, the RX processor 370, and the controller/processor 375.

In one configuration, the apparatus 1102/1102′ for wireless communication includes means for indicating resources in system information, means for receiving a data communication from the UE without establishing the RRC connection with the UE, wherein the data communication comprises data and a cause indication, means for receiving a random access preamble from the UE based on the PRACH resources associated with early data transfer, means for transmitting a random access response to the UE comprising an uplink grant for an early data transmission without establishing the RRC connection with the UE, means for forwarding the data to a core network without establishing the RRC connection with the UE, means for transmitting a downlink data communication to the UE without establishing the RRC connection with the UE. The aforementioned means may be one or more of the aforementioned components of the apparatus 1102 and/or the processing system 1214 of the apparatus 1102′ configured to perform the functions recited by the aforementioned means. As described supra, the processing system 1214 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

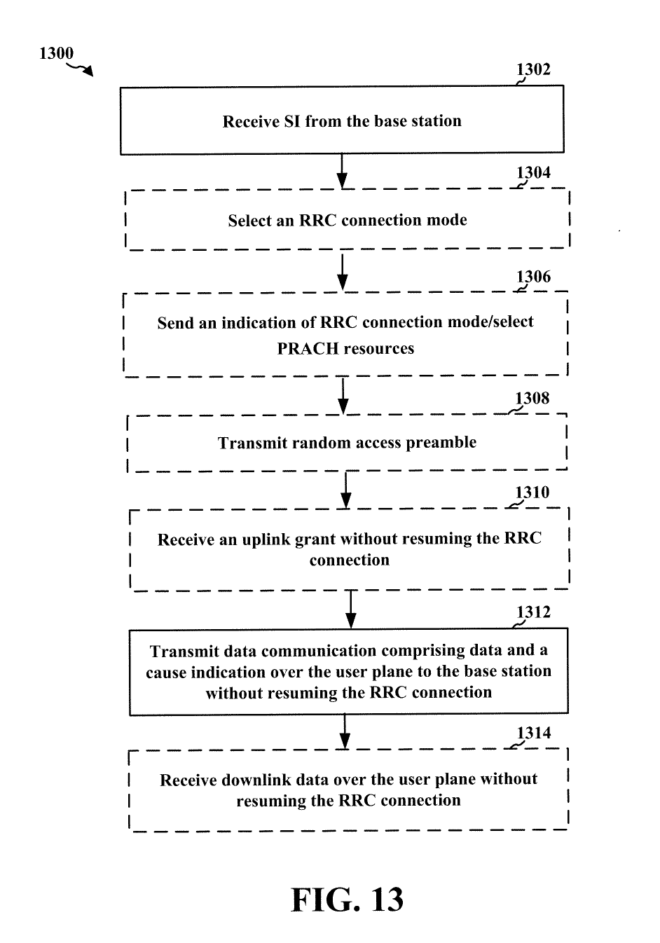

FIG. 13 is a flowchart 1300 of a method of wireless communication for early data transmission without resuming an RRC connection to a base station. For example, the UE may be in an RRC suspended state, e.g., as described in connection with FIG. 6. Optional aspects are illustrated with a dashed line. The method may be performed by a UE (e.g., the UE 104, 350, 502, 602, the apparatus 1402/1402′). The UE may comprise an NB-IoT UE, a BL UE, eMTC UE, or CE UE.

At 1302, the UE receives SI from the base station. FIG. 6 illustrate an example of SI 612 received by a UE. The SI may indicate PRACH resources to the UE. The PRACH resources may include a set of PRACH resources for early data transmission, e.g., data that is transmitted without resuming an RRC connection. The SI may also indicate the maximum size of UL data that can be transmitted by using early data transmission, e.g., over the user plane without resuming an RRC connection. The indications can be separate corresponding to different CE levels of different NPRACH resources.

As illustrated at 1304, the UE may select an RRC connection mode to transmit the data communication, e.g., selecting between an active RRC connection transmission mode and an RRC connectionless transmission mode in which the UE does not resume the RRC connection. The selection may be based on any of a number of factors, including the size of the data to be transmitted. The UE may send an indication of an RRC connection mode for sending the data communication to the base station, at 1306. The indication may comprise a selection of a PRACH resource from a pool of PRACH resources associated with early data transfer. The PRACH resource may comprise a NPRACH. The selected PRACH resources may also indicate an intention to perform a connectionless early data transmission. The SI may be broadcast from the base station and may indicate PRACH resources associated early data transmission without the UE transitioning to an RRC connected state. The UE may select a resource based at least in part on an amount of data to be transmitted in the data communication.

The data communication may be transmitted to the base station during a random access procedure in which the UE does not resume the RRC connection. At 1308, the UE may transmit a random access preamble to the base station. The random access preamble may be based on the selection at 1306 from amount PRACH resources associated with early data transfer. The UE may receive a grant for an uplink transmission without resuming the RRC connection, at 1310.

At 1312, the UE transmits a data communication to the base station over a user plane without resuming the RRC connection with the base station. The data communication may be transmitted to the base station, at 1312, based on the grant received at 1310. The data communication may comprise data and a cause indication. The data communication may comprise an RRC message. For example, the data may be multiplexed along with the RRC message, e.g., in the same transmission. This may be in contrast to the example in FIG. 7, in which the data is comprised in the RRC message and sent over the control plane. In an example, the cause indication may be comprised in the RRC message. In another example, the cause indication may be separate from the RRC message yet included in the same data communication transmission. The RRC message may comprise an RRC connection resume request along with a cause indication for the data communication. The data communication may also include a UE ID, which may be comprised in the RRC message. Thus, the user data may be multiplexed with an RRC message comprising a cause indication and/or a UE ID and sent together in the same transmission over the user plane. In another example, the data and cause may be comprised in an RRC message. In some aspects, the data may be transmitted together with a RRC connection resume message, and the cause indication may inform the base station to receive the data multiplexed with the RRC connection resume message without resuming the RRC connection. For example, the cause indication may be referred to as a cause code, a resume cause, etc. The data communication may be transmitted on a CCCH, e.g., in a NAS message. Thus, the data communication may be transmitted to the base station without the UE transitioning to an RRC connected state. The data communication may comprise a single uplink data transmission. A size of the data comprised in the single uplink data transmission may less than or equal to a size limit indicated by the base station. The data may comprise a Data PDU transmitted over a user plane, as described in connection with FIG. 6.

The data communication may further comprise UE identity information, e.g., a resume ID comprised in the RRC message, the for the UE transmitting the data over a user plane. The data communication may further comprise an authentication token. The data may be transmitted over the user plane, e.g., when a UE is in an RRC idle, suspended state.

The early data transfer may further include a small amount of downlink data received from the network. Thus, at 1314, the UE may receive a downlink data communication from the base station over the user plane without resuming the RRC connection with the base station. The downlink data communication may comprise an RRC message indicating that an early data transfer is complete. The UE may receive a single downlink data transmission, e.g., as illustrated in FIG. 6. Additional aspects described in connection with either of FIG. 5 or 6 may be performed by the UE in connection with the method of FIG. 13. The UE may remain in the RRC idle, suspended state, after transmitting and/or receiving the early data transmission.

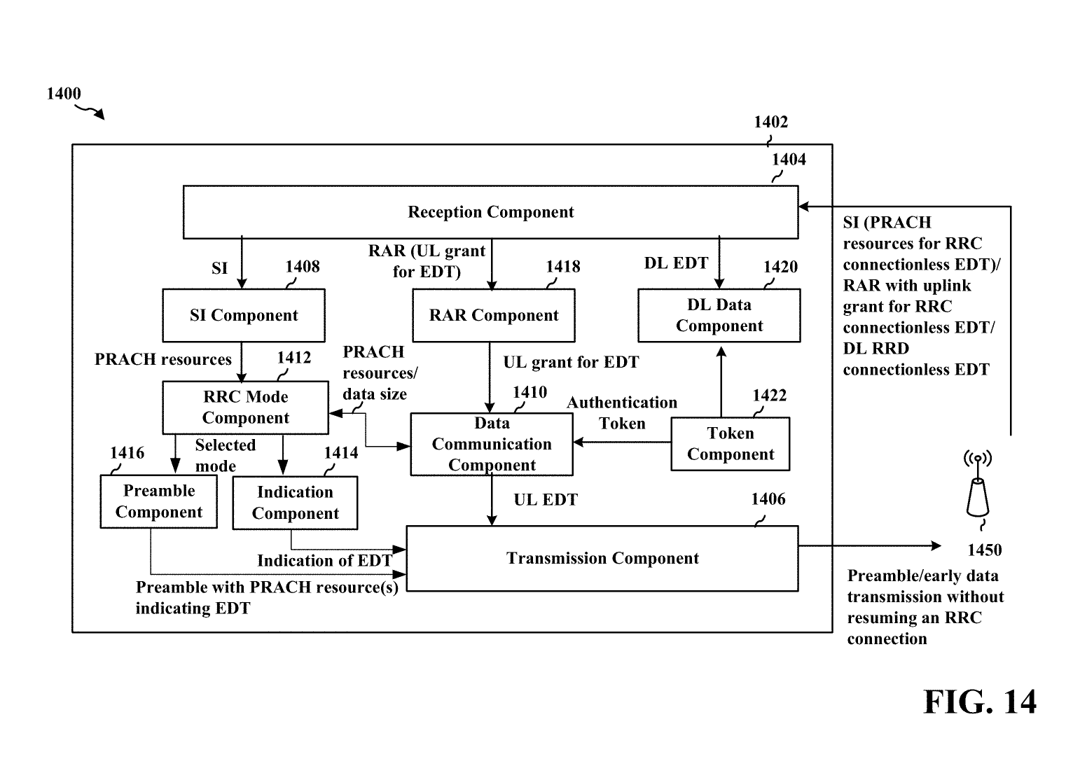

FIG. 14 is a conceptual data flow diagram 1400 illustrating the data flow between different means/components in an example apparatus 1402. The apparatus may be a UE (e.g., UE 104, 350, 502, 602) in an RRC suspended state with base station 1450. The UE may comprise an NB-IoT UE, a BL UE, eMTC UE, or CE UE, etc. The apparatus includes a reception component 1404 for receiving downlink communication from a base station 1450 and a transmission component 1406 for transmitting uplink communication to the base station 1450. The apparatus includes a system information component 1408 for receiving system information from the base station 1450 and a data communication component 1410 for transmitting a data communication to the base station over a user plane without resuming the RRC connection with the base station, wherein the data communication comprises data and a cause indication for the data communication. The apparatus may include an RRC mode component 1412 for selecting an RRC connection mode to transmit the data communication and an indication component 1414 for sending an indication of a RRC connection mode for sending the data communication to the base station. The indication may be based on PRACH resources associated with early data transfer. The apparatus may include a preamble component 1416 for transmitting a random access preamble to the base station. The apparatus may include a RAR component 1418 for receiving a RAR from the base state, which may include a grant for an uplink transmission without resuming the RRC connection. The apparatus may include a downlink data component 1420 for receiving a downlink data communication from the base station over the user plane without establishing the RRC connection with the base station. The apparatus may further comprise a token component 1422 configured to include an authentication token with the data transmitted to the base station.

The apparatus may include additional components that perform each of the blocks of the algorithm in the aforementioned flowcharts of FIGS. 6 and 13, as well as FIGS. 5 and 7. As such, each block in the aforementioned flowcharts of FIGS. 5, 6, 7, and 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

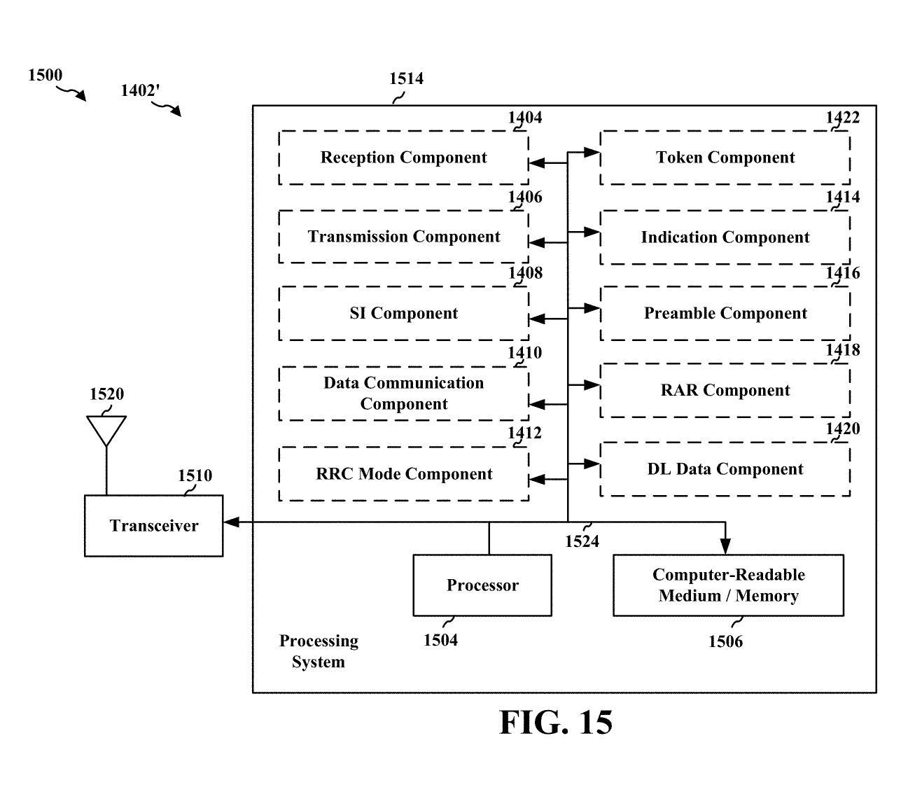

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410, 1412, 1414, 1416, 1418, 1420, 1422 and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1410, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system 1514 further includes at least one of the components 1404, 1406, 1408, 1410, 1412, 1414, 1416, 1418, 1420, 1422. The components may be software components running in the processor 1504, resident/stored in the computer readable medium/memory 1506, one or more hardware components coupled to the processor 1504, or some combination thereof. The processing system 1514 may be a component of the base station 310 and may include the memory 376 and/or at least one of the TX processor 316, the RX processor 370, and the controller/processor 375. The processing system 1514 may be a component of the UE 350 and may include the memory 360 and/or at least one of the TX processor 368, the RX processor 356, and the controller/processor 359.

In one configuration, the apparatus 1402/1402′ for wireless communication includes means for receiving system information from the base station while in an RRC suspended state; means for transmitting a data communication to the base station over a user plane without resuming an RRC connection with the base station, wherein the data communication comprises data and a cause indication for the data communication, means for selecting an RRC connection mode to transmit the data communication, means for sending an indication of a RRC connection mode for sending the data communication to the base station, means for transmitting a random access preamble to the base station, means for receiving a grant for an uplink transmission without resuming the RRC connection, wherein the data communication is transmitted to the base station based on the grant, and means for receiving a downlink data communication from the base station over the user plane without resuming the RRC connection with the base station. The aforementioned means may be one or more of the aforementioned components of the apparatus 1402 and/or the processing system 1514 of the apparatus 1402′ configured to perform the functions recited by the aforementioned means. As described supra, the processing system 1514 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

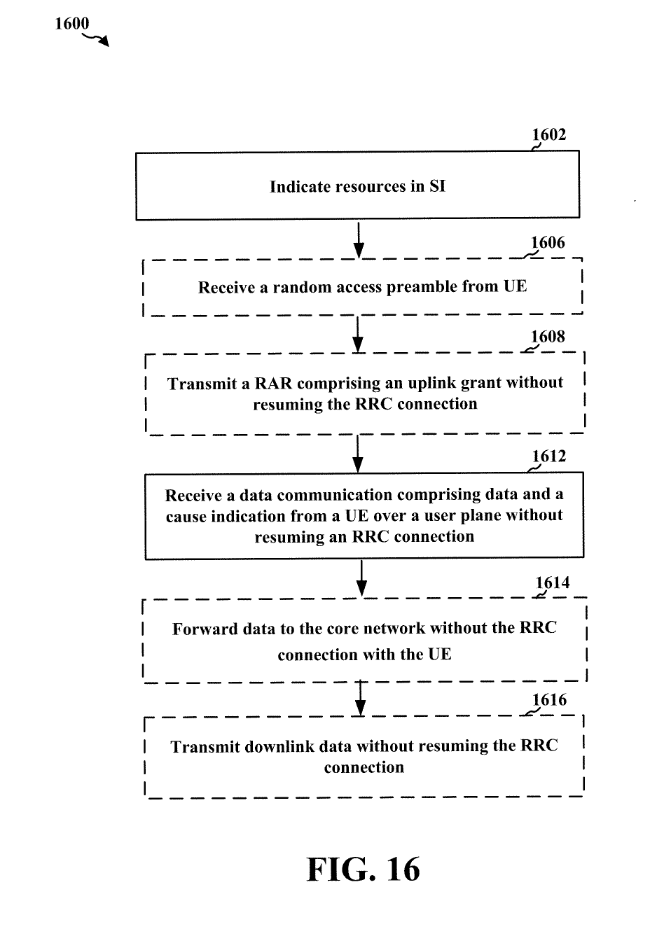

FIG. 16 is a flowchart 1600 of a method of wireless communication for early data reception without resuming an RRC connection to a UE. The method may be performed by a base station (e.g., base station 102, 180, 310, 504, 604, 850, the apparatus 1702, 1702′). The base station may be in an RRC suspended state, as described in connection with FIG. 6. Optional aspects are illustrated with a dashed line.

At 1602, the base station indicates resources in system information. FIG. 6 illustrates an example of SI 612 transmitted by a base station. The SI may indicate PRACH resources to the UE. The PRACH resources may include a set of PRACH resources for early data transmission, e.g., data that is transmitted without establishing an RRC connection. The SI may also indicate the maximum size of UL data that can be transmitted by using early data transmission. The indications can be separate corresponding to different CE levels of different NPRACH resources.

At 1612, the base station receives a data communication from the UE over the user plane without resuming the RRC connection with the UE, wherein the data communication comprises data and a cause indication. The data communication may comprise an RRC message. For example, the data may be multiplexed along with the RRC message, e.g., in the same transmission. In an example, the cause indication may be comprised in the RRC message. In another example, the cause indication may be separate from the RRC message yet included in the same data communication transmission. The RRC message may comprise an RRC connection resume request along with a cause indication for the data communication. The data communication may also include a UE ID, e.g., which may be comprised in the RRC message. Thus, the user data may be multiplexed with an RRC message comprising a cause indication and/or a UE ID and sent together in the same transmission over the user plane. In another example, the data and cause may be comprised in an RRC message. The cause indication may inform the base station to receive the data multiplexed with the RRC connection resume message without resuming the RRC connection. For example, the cause indication may be referred to as a cause code, a resume cause, etc. The cause indication may indicate to the base station that the UE intends to perform an early data transmission without resuming an RRC connection. The data may be sent together, e.g., multiplexed, in a single transmission with an RRC message indicating an intention to perform a connectionless early data transmission, e.g., without resuming the RRC connection. The data communication may be received on a CCCH, e.g., in a data PDU. Thus, the data may be received from the UE and forwarded to a core network component, at 1614, without resuming an RRC connected state with the UE, e.g., without the UE transitioning from the RRC suspended state to an RRC connected state. The data communication may comprise a single uplink data transmission. The data may comprise a Data PDU received over a user plane, as described in connection with FIG. 6.

The data communication, e.g., the RRC message, may further comprise UE identity information, e.g., a resume ID for the UE. The data communication may further comprise an authentication token, as illustrated in message 620 in FIG. 6. The data may be received over the user plane, e.g., while a UE is in an RRC idle, suspended state. In this example, the data communication may comprise an RRC connection resume message and the cause indication may inform the base station to receive the data comprised in the data communication along with the RRC connection resume message without resuming the RRC connection. The data communication may further comprise an authentication token.

The data communication may be received from the UE during a random access procedure, as illustrated in the examples in both FIGS. 5 and 6. For example, at 1606, the base station may receive a random access preamble from the UE based on the PRACH resources (e.g., NPRACH resources) associated with early data transfer. Different PRACH resources may be associated with different CE levels. In response, the base station may transmit a RAR to the UE, at 1608, the RAR comprising an uplink grant for an early data transmission without resuming the RRC connection with the UE. Then, the data communication may be received, at 1612 from the UE based on the uplink grant. FIG. 6 illustrates an example message 620 as the transmission.

The early data transfer may further include a small amount of downlink data transmitted to the UE. Thus, at 1616, the base station may transmit a downlink data communication from the base station over the user plane without establishing the RRC connection with the UE. The downlink data communication may be transmitted to the UE in an RRC message indicating to the UE that an early data transfer is complete. The base station may transmit a single downlink data transmission, e.g., as illustrated in FIG. 6. Additional aspects described in connection with either of FIG. 5 or 6 may be performed by the base station in connection with the method of FIG. 16.

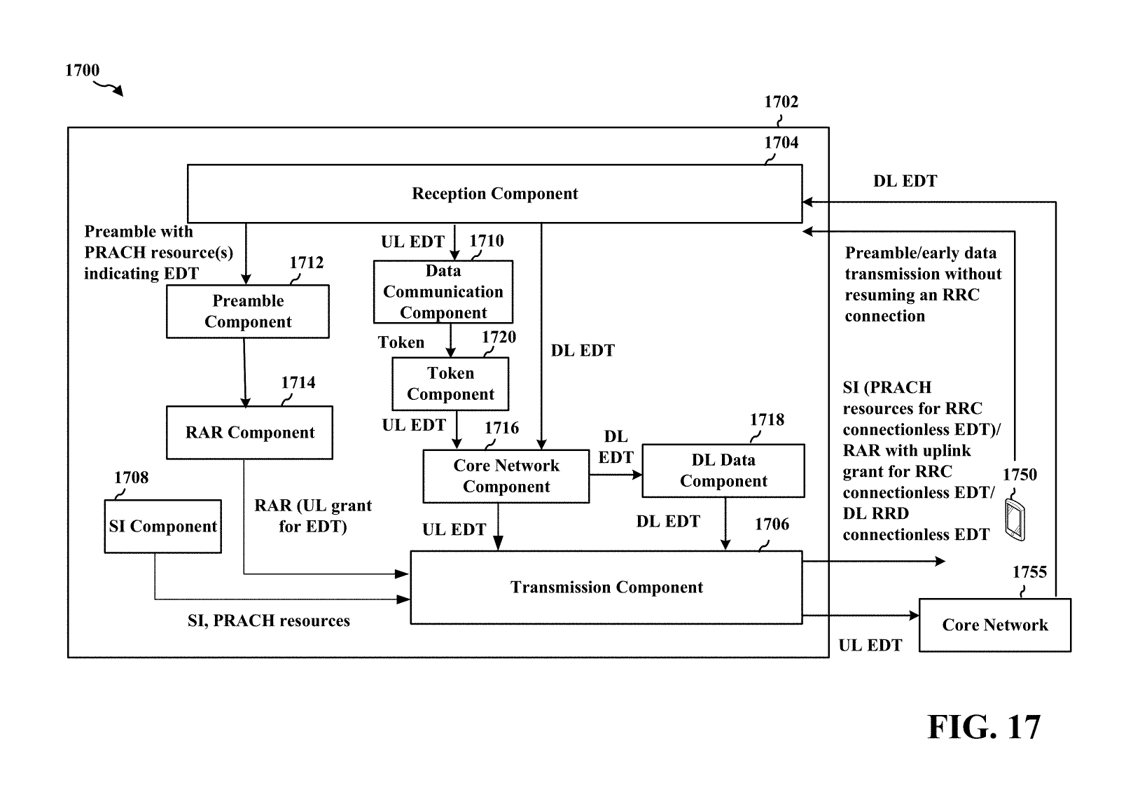

FIG. 17 is a conceptual data flow diagram 1700 illustrating the data flow between different means/components in an exemplary apparatus 1702. The apparatus may be a base station (e.g., base station 102, 180, 310, 504, 604, 850). The apparatus includes a reception component 1704 for receiving uplink communication from UE 1750 and a downlink component 1706 for transmitting downlink communication to UE and/or for communicating with a core network 1755. The apparatus includes an SI component 1708 for indicating resources in system information and a data communication component 1710 for receiving a data communication from the UE over a use plane without resuming the RRC connection with the UE, wherein the data communication comprises data and a cause indication. The data communication may be comprised in a Msg3 from the UE. The apparatus may include a preamble component 1712 for receiving a random access preamble from the UE based on the PRACH resources associated with early data transfer, and a RAR component 1714 for transmitting a random access response to the UE comprising an uplink grant for an early data transmission without resuming the RRC connection with the UE. The apparatus may include a core network component 1716 for forwarding the data to a core network without resuming the RRC connection with the UE. The apparatus may include a downlink data component 1718 for transmitting a downlink data communication to the UE over the user plane without resuming the RRC connection with the UE. The apparatus may include token component 1720 for authenticating the UE based on an authentication token comprised in the data communication.

The apparatus may include additional components that perform each of the blocks of the algorithm in the aforementioned flowcharts of FIGS. 5, 6, and 10, and 16. As such, each block in the aforementioned flowcharts of FIGS. 5, 6, and 10, and 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

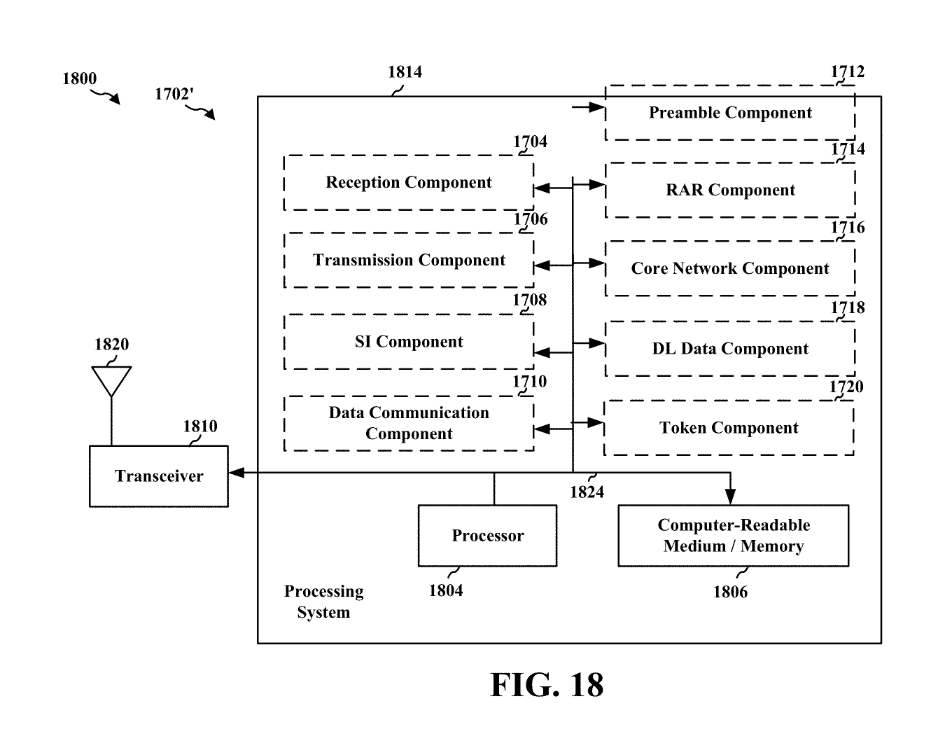

FIG. 18 is a diagram 1800 illustrating an example of a hardware implementation for an apparatus 1702′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware components, represented by the processor 1804, the components 1704, 1706, 1708, 1710, 1712, 1714, 1716, 1718, 1720, and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception component 1704. In addition, the transceiver 1810 receives information from the processing system 1814, specifically the transmission component 1706, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system 1814 further includes at least one of the components 1704, 1706, 1708, 1710, 1712, 1714, 1716, 1718, 1720. The components may be software components running in the processor 1804, resident/stored in the computer readable medium/memory 1806, one or more hardware components coupled to the processor 1804, or some combination thereof. The processing system 1814 may be a component of the base station 310 and may include the memory 376 and/or at least one of the TX processor 316, the RX processor 370, and the controller/processor 375.

In one configuration, the apparatus 1702/1702′ for wireless communication includes means for indicating resources in system information, means for receiving a data communication from the UE over a user plane without resuming an RRC connection with the UE, wherein the data communication comprises data and a cause indication; means for receiving a random access preamble from the UE based on the PRACH resources associated with the early data transmission; means for forwarding the data to a core network without resuming the RRC connection with the UE; and means for transmitting a downlink data communication to the UE over the user plane without resuming the RRC connection with the UE. The aforementioned means may be one or more of the aforementioned components of the apparatus 1702 and/or the processing system 1814 of the apparatus 1702′ configured to perform the functions recited by the aforementioned means. As described supra, the processing system 1814 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a User Equipment (UE) without a radio resource control (RRC) connection to a base station, comprising:
receiving system information from the base station; and
transmitting, by UE, a data communication to the base station over a control plane without establishing the RRC connection with the base station,
wherein the data communication comprises data and a cause indication for the data communication.

2. The method of claim 1, wherein the data communication is transmitted to the base station during a random access procedure.

3. The method of claim 1, wherein the data communication further comprises UE identity information.

4. The method of claim 3, wherein the UE identity information comprises a System Architecture Evolution TMSI (S-TMSI) for the UE.

5. The method of claim 1, wherein the data communication is comprised in an RRC message indicating an intention to perform an RRC connectionless early data transmission.

6. The method of claim 1, wherein the data communication is transmitted in a Non-Access Stratum (NAS) message on a Common Control Channel (CCCH).

7. The method of claim 1, wherein the data communication is transmitted to the base station without the UE transitioning to an RRC connected state.

8. The method of claim 1, wherein the data communication comprises a single uplink data transmission.

9. The method of claim 8, wherein a size of the data comprised in the single uplink data transmission is less than a size limit indicated by the base station.

10. The method of claim 1, further comprising:
selecting by the UE, an RRC connection mode to transmit the data communication, wherein the RRC connection mode is an active RRC connection transmission mode or an RRC connectionless transmission mode.

11. The method of claim 1, further comprising:
sending an RRC mode indication of an RRC connection mode for sending the data communication to the base station.

12. The method of claim 11, wherein the RRC mode indication comprises a selection of a physical random access channel (PRACH) resource from a pool of PRACH resources associated with an early data transmission.

13. The method of claim 12, wherein the PRACH resource comprises a NarrowBand PRACH (NPRACH).

14. The method of claim 1, further comprising:
transmitting a random access preamble to the base station; and
receiving a grant for an uplink transmission without establishing the RRC connection, wherein the data communication is transmitted to the base station based on the grant.

15. The method of claim 1, wherein the system information is broadcast from the base station and indicates resources physical random access channel (PRACH) associated with an early data transmission without the UE transitioning to an RRC connected state.

16. The method of claim 15, in which the UE selects a resource based at least in part on an amount of data to be transmitted in the data communication.

17. The method of claim 1, further comprising:
receiving a downlink data communication over the control plane from the base station without establishing the RRC connection with the base station.

18. The method of claim 17, wherein the downlink data communication is received in an RRC message indicating that an early data transfer is complete.

19. An apparatus for wireless communication by a User Equipment (UE) without a radio resource control (RRC) connection to a base station, comprising:
means for receiving system information from the base station; and
means for transmitting, by UE, a data communication to the base station over a control plane without establishing the RRC connection with the base station,
wherein the data communication comprises data and a cause indication for the data communication.

20. The apparatus of claim 19, wherein the data communication is transmitted to the base station during a random access procedure.

21. The apparatus of claim 19, further comprising:
means for selecting by the UE, an RRC connection mode to transmit the data communication, wherein the RRC connection mode is an active RRC connection transmission mode or an RRC connectionless transmission mode.

22. The apparatus of claim 19, further comprising:
means for sending an RRC mode indication of an RRC connection mode for sending the data communication to the base station.

23. The apparatus of claim 19, further comprising:
means for transmitting a random access preamble to the base station; and
means for receiving a grant for an uplink transmission without establishing the RRC connection, wherein the data communication is transmitted to the base station based on the grant.

24. The apparatus of claim 19, further comprising:
means for receiving a downlink data communication over the control plane from the base station without establishing the RRC connection with the base station.

25. An apparatus for wireless communication by a User Equipment (UE) without a radio resource control (RRC) connection to a base station, comprising:
a memory; and
at least one processor coupled to the memory and configured to:
receive system information from the base station; and
transmit, by UE, a data communication to the base station over a control plane without establishing the RRC connection with the base station,
wherein the data communication comprises data and a cause indication for the data communication.

26. The apparatus of claim 25, wherein the data communication is transmitted to the base station during a random access procedure.

27. The apparatus of claim 25, wherein the at least one processor is further configured to:
select by the UE, an RRC connection mode to transmit the data communication, wherein the RRC connection mode is an active RRC connection transmission mode or an RRC connectionless transmission mode.

28. The apparatus of claim 25, wherein the at least one processor is further configured to:
send an RRC mode indication of an RRC connection mode for sending the data communication to the base station.

29. The apparatus of claim 25, wherein the at least one processor is further configured to:
transmit a random access preamble to the base station; and
receive a grant for an uplink transmission without establishing the RRC connection, wherein the data communication is transmitted to the base station based on the grant.

30. The apparatus of claim 25, wherein the at least one processor is further configured to:
receive a downlink data communication over the control plane from the base station without establishing the RRC connection with the base station.

31. A computer-readable medium storing computer executable code for wireless communication by a User Equipment (UE) without a radio resource control (RRC) connection to a base station, comprising code to:
receive system information from the base station; and
transmit, by UE, a data communication to the base station over a control plane without establishing the RRC connection with the base station,
wherein the data communication comprises data and a cause indication for the data communication.

32. The apparatus of claim 31, wherein the data communication is transmitted to the base station during a random access procedure.

33. A method of wireless communication by a base station without a radio resource control (RRC) connection to a user equipment (UE), comprising:
indicating resources in system information; and
receiving a data communication over a control plane from the UE without establishing the RRC connection with the UE,
wherein the data communication comprises data and a cause indication.

34. The method of claim 1, wherein the data communication is received from the UE during a random access procedure.

35. The method of claim 33, wherein the data communication is comprised in a Msg3 from the UE.

36. The method of claim 33, wherein the data communication further comprises UE identity information, and wherein the UE identity information comprises a System Architecture Evolution TMSI (S-TMSI) for the UE.

37. The method of claim 33, wherein the data communication is comprised in an RRC message and the cause indication indicates an intention to perform an RRC connectionless early data transmission.

38. The method of claim 33, wherein the data communication is received in a Non-Access Stratum (NAS) message on a Common Control Channel (CCCH).

39. The method of claim 33, wherein the data communication is received from the UE and forwarded to a core network component without establishing an RRC connected state with the UE.

40. The method of claim 33, wherein the data communication comprises a single uplink data transmission.

41. The method of claim 33, wherein the resources indicated in the system information comprise physical random access channel (PRACH) resources associated with an early data transmission.

42. The method of claim 41, wherein the PRACH resources comprise a NarrowBand PRACH (NPRACH).

43. The method of claim 42, wherein different NPRACH resources are associated with different coverage enhancement levels.

44. The method of claim 41, further comprising:
receiving a random access preamble from the UE based on the PRACH resources associated with the early data transmission.

45. The method of claim 44, further comprising:
transmitting a random access response to the UE comprising an uplink grant for the early data transmission without establishing the RRC connection with the UE, wherein the data communication is received from the UE based on the uplink grant.

46. The method of claim 33, wherein the data comprises a Non-Access Stratum (NAS) Protocol Data Unit (PDU) received over the control plane.

47. The method of claim 33, further comprising:
forwarding the data to a core network without establishing the RRC connection with the UE.

48. The method of claim 33, further comprising:
transmitting a downlink data communication to the UE over the control plane without establishing the RRC connection with the UE.

49. The method of claim 48, wherein the downlink data communication is transmitted in an RRC message indicating that an early data transmission is complete.

50. An apparatus for wireless communication by a base station without a radio resource control (RRC) connection to a user equipment (UE), comprising, comprising:
means for indicating resources in system information; and
means for receiving a data communication over a control plane from the UE without establishing the RRC connection with the UE,
wherein the data communication comprises data and a cause indication.

51. The apparatus of claim 50, further comprising:
means for forwarding the data to a core network without establishing the RRC connection with the UE.

52. An apparatus for wireless communication by a base station without a radio resource control (RRC) connection to a user equipment (UE), comprising:
a memory; and
at least one processor coupled to the memory and configured to:
indicate resources in system information; and
receive a data communication over a control plane from the UE without establishing the RRC connection with the UE,
wherein the data communication comprises data and a cause indication.

53. The apparatus of claim 52, wherein the resources indicated in the system information comprise physical random access channel (PRACH) resources associated with an early data transmission, wherein the at least one processor is further configured to:
receive a random access preamble from the UE based on the PRACH resources associated with the early data transmission.

54. The apparatus of claim 53, wherein the at least one processor is further configured to:
transmit a random access response to the UE comprising an uplink grant for the early data transmission without establishing the RRC connection with the UE, wherein the data communication is received from the UE based on the uplink grant.

55. The apparatus of claim 52, wherein the at least one processor is further configured to:
forward the data to a core network without establishing the RRC connection with the UE.

56. The apparatus of claim 52, wherein the at least one processor is further configured to:
transmit a downlink data communication to the UE over the control plane without establishing the RRC connection with the UE.

57. A computer-readable medium storing computer executable code for wireless communication by a base station without a radio resource control (RRC) connection to a user equipment (UE), comprising code to:
indicate resources in system information; and
receive a data communication over a control plane from the UE without establishing the RRC connection with the UE,
wherein the data communication comprises data and a cause indication.
